(19) United States
(12) Patent Application Publication
(10) Pub. No.: US 2025/0001519 A1
(43) Pub. Date: Jan. 2, 2025

(54) LASER PROCESSING APPARATUS, PROBE CARD PRODUCTION METHOD, AND LASER PROCESSING METHOD

(71) Applicant: KATAOKA CORPORATION, Kyoto (JP)

(72) Inventors: Osamu ENDO, Kyoto (JP); Shinichi NAKASHIBA, Kyoto (JP)

(73) Assignee: KATAOKA CORPORATION, Kyoto (JP)

(21) Appl. No.: 18/291,456

(22) PCT Filed: Aug. 30, 2022
(86) PCT No.: PCT/JP2022/032687

§ 371 Date: Jan. 23, 2024

(30) Foreign Application Priority Data
Sep. 16, 2021 (JP) 2021-151441

(51) Int. Cl. B23K 26/06; B23K 26/046; B23K 26/073; B23K 26/082; B23K 26/382; B23K 101/36

(52) U.S. Cl. CPC B23K 26/0648; B23K 26/046; B23K 26/0732; B23K 26/0734; B23K 26/082; B23K 26/382; B23K 2101/36

(57) ABSTRACT

A laser processing apparatus for processing a workpiece by applying laser beam to the workpiece, including: a laser oscillator capable of emitting laser beam; a beam rotator that converts the laser beam emitted from the laser oscillator into a circular beam having a predetermined diameter; a beam shaper on which the circular beam emitted from the beam rotator is incident and from which a polygonal beam is emitted; and a focusing optical system that focuses the polygonal beam emitted from the beam shaper on the workpiece, wherein the beam shaper is a DOE-type beam shaper, and the outer peripheral diameter of the circular beam incident on the DOE-type beam shaper is larger than a standard incident beam diameter preset for the DOE-type beam shaper.

### TECHNICAL FIELD

The present invention relates to a laser processing apparatus, a method for producing a probe card, and a laser processing method.

### BACKGROUND ART

Laser processing apparatuses have been used to perform micromachining of various materials such as metals, resins, and ceramic materials. For example, Patent Document 1 discloses a laser processing apparatus adapted to reduce the influence of reflected laser beam and capable of performing drilling with high accuracy.

### CITATION LIST

### Patent Document

Patent Document 1: JP 2009-233714 A

### SUMMARY OF INVENTION

### Technical Problem

When laser processing is performed to drill a hole in a workpiece, the accuracy of the shape of the hole is required. For example, in the case where a hole that is quadrilateral on a laser beam incident-side surface (hereinafter referred to as “IN-side surface”) of the workpiece is to be formed, it is required that the hole after the processing be such that four corners of the quadrilateral shape are substantially right-angled rather than rounded.

However, since laser processing apparatuses typically use circular laser beam to process a workpiece, there is a problem in that, especially when forming a hole in a shape having corners, the corners of the hole formed in the workpiece after the processing have roundness in accordance with the radius (R) of the laser beam.

One possible option to address this problem is to use rectangular laser beam instead of circular laser beam in order to make four corners of a quadrilateral hole substantially right-angled. For example, there has been known a beam shaper that converts a circular Gaussian beam into a rectangular beam utilizing diffraction, refraction, total reflection, or the like of light (hereinafter referred to as “conventional processing apparatus”, “conventional method”, “conventional laser processing”, or “conventional example”). Although such a beam shaper can make the shape of laser beam rectangular, it is not effective enough to solve the above-described problem because, when the resulting rectangular beam is used for drilling, the energy intensity is not sufficiently high at the corners of the rectangular beam, thereby causing a quadrilateral hole formed in a workpiece to have rounded corners.

With the foregoing in mind, it is an object of the present invention to provide a laser processing apparatus that enables accurate micromachining of a shape having corners with respect to a laser beam IN-side surface of a workpiece by controlling the energy intensity distribution of laser beam incident on a beam shaper.

### Solution to Problem

In order to achieve the above object, the present invention provides a laser processing apparatus for processing a workpiece by applying laser beam to the workpiece, including: a laser oscillation unit capable of emitting laser beam: a beam conversion unit that shapes the laser beam emitted from the laser oscillation unit into a circular beam having a predetermined diameter: a polygonal beam shaping unit on which the circular beam emitted from the beam conversion unit is incident and from which a polygonal beam is emitted; and a focusing optical system that condenses the polygonal beam emitted from the polygonal beam shaping unit on the workpiece, wherein the polygonal beam shaping unit is a diffractive optical element-type beam shaper, and an outer peripheral diameter of the circular beam incident on the diffractive optical element-type beam shaper is larger than a standard incident beam diameter preset for the diffractive optical element-type beam shaper.

The present invention also provides a method for producing a probe card, including the step of: drilling a hole in a board of a probe card using the laser processing apparatus.

The present invention also provides a laser processing method for use in a laser processing apparatus that includes a laser oscillation unit, a beam conversion unit, a polygonal beam shaping unit, and a focusing optical system, the laser processing method including: a first step in which the laser conversion unit converts laser beam emitted from the laser oscillation unit into a circular beam having a predetermined diameter: a second step in which the polygonal beam shaping unit shapes the circular beam emitted from the beam conversion unit into a polygonal beam; and a third step in which the focusing optical system focuses the polygonal beam emitted from the polygonal beam shaping unit on a workpiece, wherein in the second step, a diffractive optical element-type beam shaper is used as the polygonal beam shaping unit, and an outer peripheral diameter of the circular beam incident on the diffractive optical element-type beam shaper is larger than a standard incident beam diameter preset for the diffractive optical element-type beam shaper.

### Advantageous Effects of Invention

The laser processing apparatus of the present invention enables accurate micromachining of a shape having corners, such as drilling of a quadrilateral hole whose four corners are approximately right-angled, in a workpiece.

### BRIEF DESCRIPTION OF THE DRAWINGS

FIG. 1 is a schematic diagram showing an example of the configuration of a laser processing apparatus of a first embodiment.

FIG. 2 shows diagrams for illustrating a beam shaper that converts a Gaussian beam into a top-hat beam.

FIG. 3 is a schematic diagram showing an example of the configuration of a beam rotator (beam conversion unit) in the laser processing apparatus of the first embodiment.

FIG. 4 shows schematic diagrams showing an example of processing of laser beam in the beam rotator of the first embodiment.

FIG. 5 shows schematic diagrams showing another example of processing of laser beam in the beam rotator of the first embodiment.

FIG. 6 shows schematic diagrams showing an example of processing of laser beam in a beam shaper (polygonal beam shaping unit) of the first embodiment.

FIG. 7 shows diagrams for illustrating effects of the first embodiment.

FIG. 8 is a schematic diagram showing an example of the configuration of a laser processing apparatus of a second embodiment.

FIG. 9 shows schematic diagrams showing an example of processing of laser beam in a slit of the second embodiment.

FIG. 10 shows photographs for illustrating effects of the second embodiment.

FIG. 11 is a schematic diagram showing an example of the configuration of a laser processing apparatus of a third embodiment.

FIG. 12 shows schematic diagrams showing an example of processing of laser beam in axicon lenses (beam conversion units) of the third embodiment.

FIG. 13 is a schematic diagram showing an example of processing of laser beam in a beam shaper (polygonal beam shaping unit) of the third embodiment.

FIG. 14 is a schematic diagram showing an example of the configuration of a processing system including a laser processing apparatus and a terminal of a fourth embodiment.

FIG. 15 is a schematic diagram showing the configuration and function of a polarization rotator of the fourth embodiment.

FIG. 16 is a schematic diagram illustrating the function of a motor synchronous control unit of a control unit of the fourth embodiment and synchronous control of the polarization rotator and a beam rotator.

FIG. 17 is a schematic diagram illustrating the control of the rotational phase difference between the polarization rotator and the beam rotator in the processing apparatus of the fourth embodiment.

FIG. 18 shows schematic diagrams illustrating the control of the rotational phase difference between the polarization rotator and the beam rotator in the processing apparatus of the fourth embodiment.

FIG. 19 shows schematic diagrams illustrating the control of the rotational phase difference between the polarization rotator and the beam rotator in the processing apparatus of the fourth embodiment.

FIG. 20 is a schematic diagram showing the polarization state of laser beam in the processing apparatus of the fourth embodiment.

FIG. 21 shows photographs showing the energy densities of laser beam applied to plates and quadrilateral holes formed in the plates in the respective embodiments.

FIG. 22, which shows the results of drilling using the laser processing apparatuses of the respective embodiments, shows photographs showing the energy intensity distributions of laser beam applied to plates and quadrilateral holes formed in the plates.

### DESCRIPTION OF EMBODIMENTS

### <Definition>

The term “workpiece” as used herein means an object to be processed using a laser. There is no particular limitation on the material, size, shape, etc. of the workpiece, and they may be set freely as long as the workpiece can be processed using laser beam. The workpiece may be made of any material that can be processed using laser beam, and examples of the material include: metals such as iron, stainless steel, aluminum, and copper and alloys: resins; and ceramic materials.

The term “process (and grammatical variations thereof)” as used herein means the act of treating a workpiece, i.e., the act of processing a workpiece. Specific examples thereof include cutting, hole (including a bottomed hole and a through hole) drilling (hole formation), grooving (scribing), trimming, marking (removing or coloring), welding, lift-off, additive manufacturing (e.g., 3D printer), and peeling. In the processing, a hole or the like to be formed in the workpiece can have any shape, and the shape may be, for example, a polygonal shape: a circular shape such as a perfect circle or an oval; or a shape combining these shapes.

The term “polygonal shape” as used herein means a shape having a plurality of corners. The polygonal shape is, for example, a shape having n corners (n is an integer of 2 or more), and specific examples of the polygonal shape include triangular, quadrilateral, pentagonal, and hexagonal shapes.

The term “eccentric” as used herein means that the central axis of an object of interest is offset from the central axis of a reference object.

The term “beam shape” as used herein means a cross-sectional shape of laser beam orthogonal to the central axis of the laser beam.

The term “outer peripheral shape of a beam” as used herein means the outer peripheral shape of a cross-section of laser beam orthogonal to the central axis of the laser beam or the outer peripheral shape of the energy intensity distribution of a cross-section of laser beam orthogonal to the central axis of the laser beam.

The term “averaged energy intensity distribution” as used herein means the average energy intensity distribution of laser beam emitted from a laser oscillation unit as determined based on the assumption that the laser beam has rotated one turn (360°) about the optical axis of the laser beam from a reference position.

The term “laser beam incident-side surface” (IN-side surface) as used herein means a surface of an object to be irradiated with laser beam, including a portion to be irradiated with the laser beam.

The term “laser beam emitting-side surface” (OUT-side surface) as used herein means a surface of an object to be irradiated with laser beam, opposite to a surface of the object including a portion to be irradiated with the laser beam.

The term “probe card” as used herein means an instrument used for electrical testing of semiconductor integrated circuits in wafer inspection of the semiconductor integrated circuits.

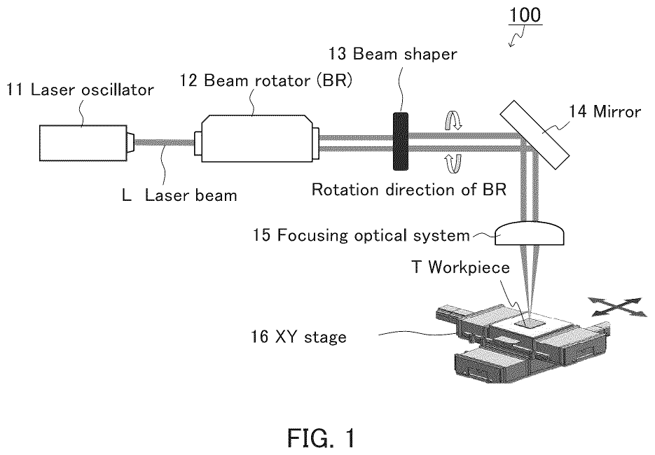

A laser processing apparatus of the present invention and a laser processing method using the same will be described in detail below with reference to the drawings. It is to be noted, however, that the present invention is not limited by the following description. In FIGS. 1 to 22 to be described below, identical parts are given the same reference numerals, and duplicate explanations thereof may be omitted. In the drawings, the structure of each part may be shown in a simplified form as appropriate for the sake of convenience in explanation, and each part may be shown schematically with a dimensional ratio and the like that are different from the actual dimension ratio and the like. Unless otherwise stated, descriptions regarding the respective embodiments are applicable to each other and may be combined with each other.

### First Embodiment

In the present embodiment, a laser processing apparatus 100 for forming quadrilateral holes in workpieces will be described with reference to FIGS. 1 to 7.

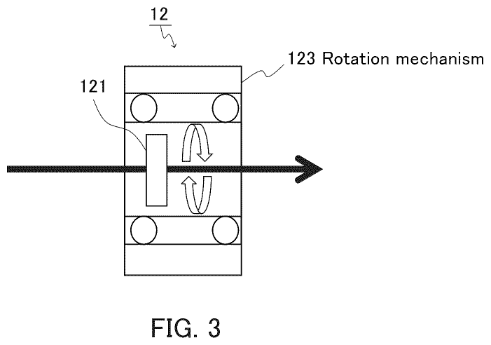

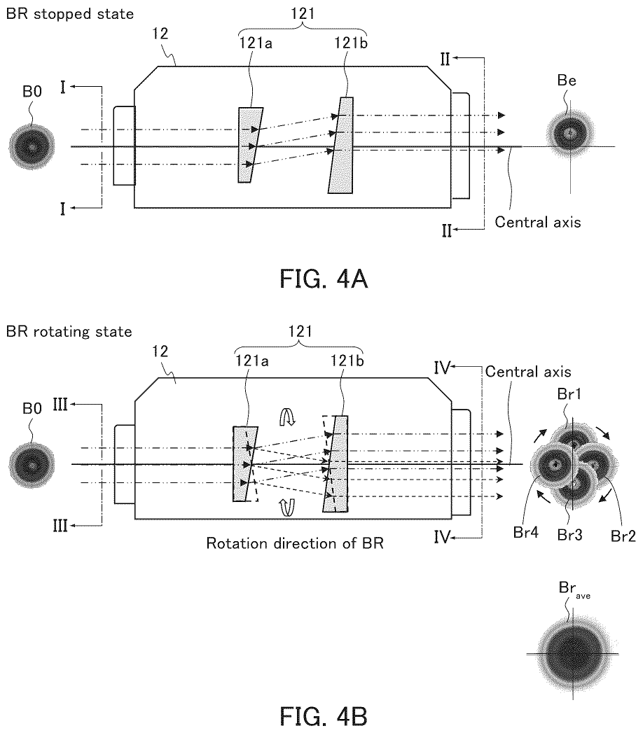

As shown in FIG. 1, the laser processing apparatus 100 includes a laser oscillator (laser oscillation unit) 11, a beam rotator (beam conversion unit) 12, a beam shaper (polygonal beam shaping unit) 13, a mirror 14, a condenser lens 15 (focusing optical system), and an XY stage 16 (processing stage). As shown in FIGS. 3 and 4, the beam rotator 12 includes: an eccentric optical system 121 made up of two lenses (wedge prisms) 121a and 121b; and a rotation mechanism 123.

### (1) Laser Oscillator 11

The laser oscillator 11 emits laser beam L used for processing of a workpiece T. That is to say, the laser oscillator 11 serves as a light source of the laser beam L. Specifically, the laser oscillator 11 may be a known laser beam source, examples of which include: solid-state laser beam sources such as a YAG laser, a YVO4 laser, and a fiber laser; gas laser beam sources such as a CO₂ laser; and semiconductor laser beam sources. The output, wavelength, and other conditions of the laser oscillator 11 can be set as appropriate according to the type of processing and the workpiece T.

As shown in FIG. 1, the laser beam L emitted from the laser oscillator 11 is applied to the workpiece T placed on the XY stage 16 after passing through the beam rotator 12, the beam shaper 13, the mirror 14, and the focusing optical system 15.

In the first embodiment, the central axis of the laser beam L generated by the laser oscillator 11, the central axis and the rotation axis of the beam rotator 12, and the central axis of the beam shaper 13 extend coaxially.

The output waveform of the laser oscillator 11 may be a continuous wave (CW), or may be pulse oscillation such as switching pulse oscillation, pulse oscillation, enhanced pulse oscillation, hyper pulse oscillation, or Q-switched pulse oscillation. That is, the type of laser beam L emitted from the laser oscillator 11 may be a pulsed laser or a continuous wave laser.

When the laser oscillator 11 emits a pulsed laser, the frequency of the laser beam L may be set as appropriate according to the type of processing and the workpiece T, for example. As a specific example, when forming a hole in a metal workpiece, the frequency of the laser beam L may be set in the range from 2 kHz to 3 kHz, for example.

The laser beam L used in the first embodiment is a Gaussian beam, and the outer peripheral beam shape thereof is circular. In one example, the polarized pattern of the laser beam L is linear polarization.

In the laser processing apparatus 100 of the first embodiment, the laser beam L generated by the laser oscillator 11 directly enters the beam rotator 12. It is to be noted, however, that the present invention is not limited thereto, and the laser processing apparatus 100 may further include an additional member.

The additional member may include, for example, an optical system for changing the diameter (outer peripheral diameter or outer diameter) of a beam, such as a beam expander, or a beam shaping optical system such as an aperture (diaphragm or opening). The laser processing apparatus 100 provided with such a member can make the laser beam L incident on the beam rotator 12 after adjusting the outer peripheral shape of the beam of the laser beam L emitted from the laser oscillator 11.

### (2) Beam Rotator 12 and Beam Shaper 13

Next, the beam rotator 12 and the beam shaper 13, which are characteristic components of the first embodiment, will be described.

In general, beam shapers are optical elements for shaping a Gaussian beam into desired beam profiles such as a top-hat beam, a doughnut beam, and a ring beam so as to conform to various applications.

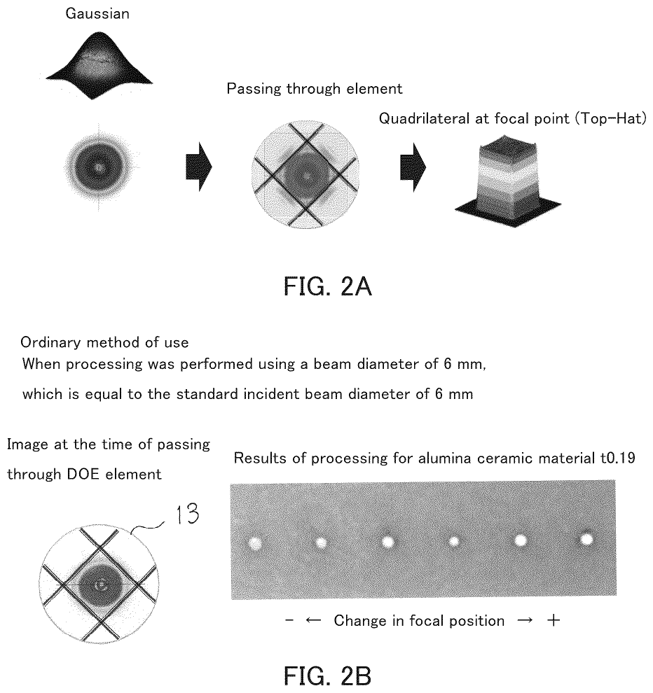

The beam shaper 13 of the first embodiment is a diffractive optical element-type beam shaper that utilizes diffraction phenomenon of light and shapes a Gaussian beam into a top-hat beam that forms a rectangular focal point, as shown in FIG. 2A.

The specifications of the beam shaper 13 specify the standard incident beam diameter (Bₛ). In an ordinary method of use where the beam shaper 13 shapes the beam shape into a rectangular shape, when laser beam whose diameter is equal to the specified standard incident beam diameter (Bₛ) is incident on the central axis of the beam shaper 13, the laser beam is shaped into a top-hat beam with a spot size as specified in the specifications.

FIG. 2B shows the result of processing when laser beam whose diameter is equal to the standard incident beam diameter (Bₛ) was made incident on the beam shaper 13 and drilling was performed using the laser beam that had been shaped into a rectangular beam as specified in the specifications. As can be seen from FIG. 2B, even when the rectangularly-shaped laser beam was used, holes formed by the drilling were nearly circular and totally different from desired quadrilateral holes. The cause thereof is considered to be that the rectangular laser beam does not have sufficiently high energy intensity at its corners.

Thus, in the first embodiment, in order to obtain a desired quadrilateral hole by sharpening the four corners thereof to make them substantially right-angled, the beam rotator 12 and the beam shaper 13 are devised so as to ensure sufficiently high energy intensity at the corners of rectangular laser beam. This will be described in detail below.

First, the configuration and the function of the beam rotator 12 will be described with reference to FIGS. 3 and 4.

As shown in FIGS. 3 and 4, the beam rotator 12 includes: the eccentric optical system 121 made up of the two lenses (wedge prisms) 121a and 121b; and the rotation mechanism 123.

The eccentric optical system 121 is configured to be rotatable by a motor such as a servo motor, for example. The rotation mechanism 123 may be the combination of a bearing such as a slide bearing, ball bearing, roller bearing, or needle bearing and a motor such as a servo motor capable of rotating the eccentric optical system 121. The eccentric optical system 121 includes the wedge prisms 121a and 121b, and the wedge prisms 121a and 121b are configured to be movable in parallel with the central axis (rotation axis). With this configuration, the beam rotator 12 makes the laser beam L incident on the beam shaper 13 at a position eccentric from the center axis of the beam shaper 13.

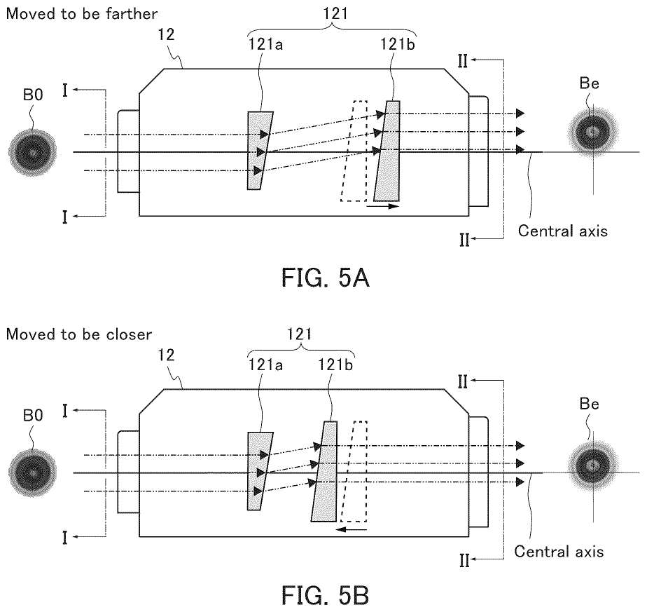

Next, the beam rotator 12 will be described more specifically with reference to FIGS. 4 and 5.

FIG. 4A shows the state where the rotation mechanism 123 is temporarily stopped (BR stopped state), and FIG. 4B shows the state where the rotation mechanism 123 is rotating (BR rotating state), which corresponds to the state in normal use. FIG. 5A shows the state where the wedge prisms 121a and 121b are arranged such that the distance between them is relatively long, and FIG. 5B shows the state where the wedge prisms 121a and 121b are arranged such that the distance between them is relatively short.

In FIGS. 4A, 5A, and 5B, B0 shows the energy intensity distribution of the laser beam L (beam) viewed along arrows I-I, and Be shows the energy intensity distribution of the laser beam L (beam) viewed along arrows II-II. Double-dot-dashed lines in FIGS. 4A, 5A, and 5B illustrate the movement of the laser beam L.

In FIG. 4B, B0 shows the energy intensity distribution of the laser beam L (beam) viewed along arrows III-III, and Br1 to Br4 each show the energy intensity distribution of the laser beam L (beam) viewed along arrows IV-IV. Brₐᵥₑ shows the averaged energy intensity distribution of the laser beam L (beam) viewed along the arrows IV-IV. In FIG. 4B, the double-dot-dashed lines illustrate the movement of the laser beam L when the wedge prisms 121a and 121b are at positions indicated with solid lines, and dashed lines illustrate the movement of the laser beam L when the wedge prisms 121a and 121b are at positions indicated with dashed lines, i.e., when the wedge prisms 121a and 121b indicated with the solid lines has been rotated 180° about the central axis (rotation axis). In FIGS. 5A and 5B, a dashed line shows the position of the wedge prism 121b in FIG. 4A.

As shown in FIG. 4A, in the BR stopped state, the laser beam L emitted from the laser oscillator 11 is incident perpendicularly on the right-angle surface of the wedge prism 121a along the central axis of the beam rotator 12. Then, at the time when the laser beam L is emitted from the sloping surface of the wedge prism 121a, the laser beam L is deflected at a predetermined angle (deflection angle) in accordance with the wedge angle of the sloping surface.

Subsequently, the laser beam L is incident on the sloping surface of the wedge prism 121b. At the time when the laser beam L is incident on the sloping surface of the wedge prism 121b, the laser beam L is deflected at a predetermined angle (deflection angle) in accordance with the wedge angle of the sloping surface. Then, the laser beam L is emitted perpendicularly from the right-angle surface of the wedge prism 121b. In the processing apparatus 100 of the first embodiment, the sloping surfaces of the wedge prisms 121a and 121b are in parallel with each other, i.e., the wedge prisms 121a and 121b have the same deflection angle. With this configuration, the laser beam L emitted after passing through the beam rotator 12 and the eccentric optical system 121 is eccentric from and in parallel with the central axis of the beam rotator 12.

Accordingly, on a plane orthogonal to the central axis, the energy intensity distribution Be of the laser beam L emitted from the beam rotator 12 has moved to a position eccentric from the central axis of the beam rotator 12, i.e., a position apart from the central axis, as compared to the energy intensity distribution B0 of the laser beam L before being incident on the beam rotator 12.

Since the central axes of the beam rotator 12 and the beam shaper 13 are set to be coaxal as described above, the laser beam L emitted from the beam rotator 12 is incident on the beam shaper 13 at a position eccentric from the central axis of the beam shaper 13.

The degree of eccentricity (the amount of eccentricity) of the laser beam L can be adjusted by changing the relative distance between the wedge prisms 121a and 121b.

Specifically, with the distance between the wedge prisms 121a and 121b shown in FIG. 4A as a reference distance, when at least one of the wedge prisms 121a and 121b is moved to make the distance between the wedge prisms 121a and 121b relatively long, the degree of eccentricity of the laser beam L increases as shown in FIG. 5A. That is, the distance by which the energy intensity distribution Be moves from the central axis increases.

On the other hand, when at least one of the wedge prisms 121a and 121b is moved to make the distance between the wedge prisms 121a and 121b relatively short, the degree of eccentricity of the laser beam L decreases as shown in FIG. 5B. That is, the distance by which the energy intensity distribution Be moves from the central axis decreases.

Thus, the beam rotator 12 can adjust the degree of eccentricity of the laser beam L, i.e., the distance by which the energy intensity distribution Be moves from the central axis.

Next, in the BR rotating state, the wedge prisms 121a and 121b rotate in synchronization with each other along with the rotation of the rotation mechanism 123. As a result, the laser beam L emitted from the beam rotator 12 rotates at a position eccentric from the central axis of the beam rotator 12, as shown in FIG. 4B.

That is, at an initial position at the start of rotation shown in FIG. 4A, the energy intensity distribution of the laser beam L after being emitted is Br1. Then, along with the rotation of the rotation mechanism 123 and the wedge prisms 121a and 121b, the energy intensity distribution of the laser beam L after being emitted changes its position continuously from Br1 to Br2, Br3, Br4, and Br1 about the central axis.

Accordingly, the averaged energy intensity distribution obtained by averaging the energy intensity distributions of the laser beam L after being emitted in the BR rotating state is Brₐᵥₑ shown in FIG. 4B. It is preferable that the rotational speed achieved by the rotation mechanism 123 be substantially constant in order to reduce the variation of Brₐᵥₑ. As described above, the beam rotator 12 has functions of causing eccentricity and effecting rotation and can convert the energy intensity distribution of the laser beam L to be incident on the beam shaper 13 from B0 into Brₐᵥₑ.

In other words, the beam rotator 12 has a function of converting the laser beam L emitted from the laser oscillator 11 into a circular beam having a predetermined diameter, i.e., a function of converting the outer peripheral diameter (the diameter of the outer periphery) or outer diameter of the circular beam into a desired length. The beam rotator 12 also has a function of converting the laser beam L emitted from the laser oscillator 11 into a circular beam in which energy intensity on a side closer to the outer periphery than to the optical axis thereof is higher than energy intensity near the optical axis. The beam rotator 12 also has a function of converting the laser beam L emitted from the laser oscillator 11 into an annular beam.

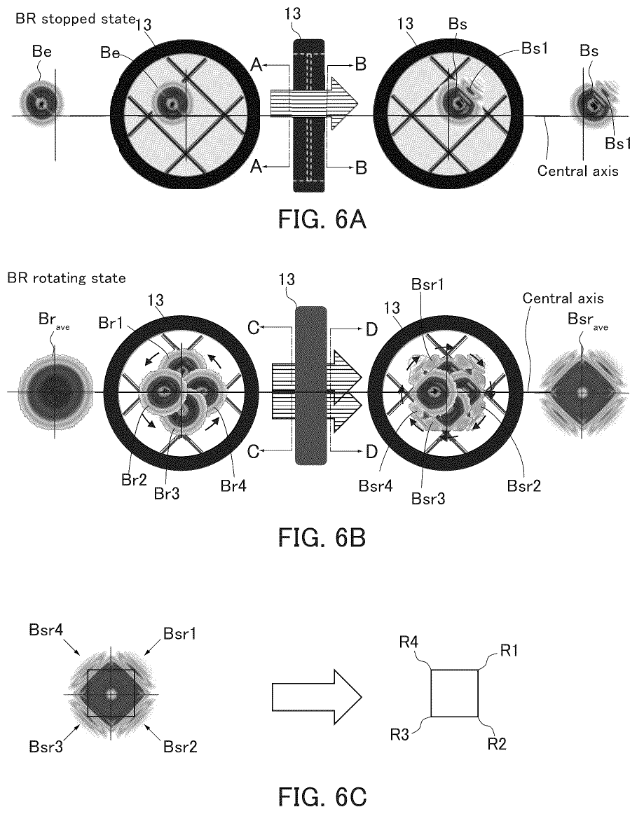

Next, the function of the beam shaper 13 will be described with reference to FIG. 6. The beam shaper 13 is a beam shaping unit that converts a beam mode.

In the laser processing apparatus 100 of the first embodiment, the beam shaper 13 is a diffractive optical element (DOE)—type beam shaper that converts the outer peripheral shape of the beam of laser beam L into a quadrilateral shape, and the standard incident beam diameter (Bₛ) is 6 mm. The lattice pattern inside the beam shaper 13 shown in FIGS. 6A and 6B schematically shows the diffraction grating of the beam shaper 13.

FIG. 6A shows the state where the rotation mechanism 123 is temporarily stopped (BR stopped state), and FIG. 6B shows the state where the rotation mechanism 123 is rotating (BR rotating state), which corresponds to the state in normal use.

In FIG. 6A, Be shows an example of the energy intensity distribution of the laser beam L (beam) viewed along arrows A-A, and Bₛ shows an example of the energy intensity distribution of the laser beam L (beam) viewed along arrows B-B. In FIG. 6B, Br1 to Br4 each show an example of the energy intensity distribution of the laser beam L (beam) viewed along arrows C-C, and Brₐᵥₑ shows an example of the averaged energy intensity distribution of the laser beam L (beam) viewed along arrows C-C. Bsr1 to Bsr4 each show an example of the energy intensity distribution of the laser beam L (beam) viewed along arrows D-D, and Bsrₐᵥₑ shows an example of the averaged energy intensity distribution of the laser beam L (beam) viewed along arrows D-D. In FIGS. 6A and 6B, arrows passing through the beam shaper 13 illustrate the movement of the laser beam L. Black arrows in FIG. 6B indicate the rotation direction of the laser beam L.

As shown in FIG. 6A, in the BR stopped state, the laser beam L emitted from the beam rotator 12 is incident on the beam shaper 13 at a position eccentric from and in parallel with the central axes of the beam rotator 12 and the beam shaper 13. Then, the energy intensity distribution of the beam of the laser beam L is converted by a diffractive optical element provided inside the beam shaper 13.

Specifically, the energy intensity of the laser beam L passing through a region of a quadrilateral shape (lattice pattern) in a central portion of the beam shaper 13 (in-boundary region of the beam shaper 13) is maintained or made uniform. On the other hand, the energy intensity of the laser beam L passing through or coming into contact with a region outside the quadrilateral shape (lattice pattern) in the central portion of the beam shaper 13 (out-of-boundary region of the beam shaper 13) is enhanced owing to the action of diffraction phenomenon of light, i.e., the action of diffracted light components.

This will be explained more specifically with reference to FIG. 6A. At the sides of the quadrilateral shape (lattice pattern) in the central portion of the beam shaper 13, a relatively large amount of laser beam is incident on the out-of-boundary region. In contrast, at the apex portions of the quadrilateral shape (lattice pattern) in the central portion of the beam shaper 13, the amount of laser beam incident on the out-of-boundary region is smaller. As a result, the laser beam L emitted from the beam shaper 13 is eccentric from and in parallel with the central axis of the beam shaper 13, and its energy intensity distribution Bs is such that the energy intensity in a portion Bs1 is enhanced owing to the diffraction phenomenon of light as compared to the energy intensity distribution Be of the laser beam L before being incident. This portion Bs1 with the enhanced energy plays a role of sharpening the corners of the quadrilateral hole.

Next, as shown in FIG. 6B, in normal use (BR rotating state), the wedge prisms 121a and 121b rotate in synchronization with each other along with the rotation of the rotation mechanism 123. With this configuration, the energy intensity distribution of the laser beam L after being emitted from the beam rotator 12 rotates at a position eccentric from the central axis of the beam shaper 13.

That is, at an initial position at the start of rotation shown in FIG. 6B, the energy intensity distribution of the laser beam L after being emitted is Br1. Then, along with the rotation of the rotation mechanism 123 and the wedge prisms 121a and 121b, the energy intensity distribution of the laser beam L after being emitted changes its position continuously from Br1 to Br2, Br3, Br4, and Br1 about the central axis. Accordingly, the averaged energy intensity distribution obtained by averaging the energy intensity distributions of the laser beam L incident from the beam rotator 12 in the BR rotating state is Brₐᵥₑ.

As described above, the energy intensity of the laser beam L passing through or coming into contact with the out-of-boundary region of the beam shaper 13 is enhanced owing to the action of diffracted light components. That is, in the averaged energy intensity distribution Brₐᵥₑ, the energy intensity at portions (Bsr1, Bsr2, Bsr2, Bsr4) indicated by arrows in FIG. 6C is enhanced. The diffracted light components at these four points indicated by the arrows serve as components that sharpen four corners when drilling a quadrilateral hole in the workpiece T. Specifically, when drilling the quadrilateral hole, the diffracted light components at Bsr1 act to sharpen a corner R1, the diffracted light components at Bsr2 act to sharpen a corner R2, the diffracted light components at Bsr3 act to sharpen a corner R3, and the diffracted light component at Bsr4 act to sharpen a corner R4.

That is, drilling performed using the laser processing apparatus 100 of the first embodiment forms, instead of a quadrilateral hole formed by drilling according to an ordinary method of use in which a Gaussian beam is converted into a rectangular beam as shown in FIG. 2, a quadrilateral hole corresponding to one obtained by rotating the quadrilateral hole formed by the above-described ordinary method of use by 45 degrees.

In the first embodiment, in order to more effectively produce the above-described diffracted light components at the four points, laser beam L having a diameter larger than the standard incident beam diameter (Bₛ) set for the beam shaper 13 is made incident on the beam shaper 13. That is, the incident beam diameter (B_{I}) of the laser beam L incident on the beam shaper 13 satisfies B_{I}>Bₛ. In order to sharpen the corners of a polygonal hole such as a quadrilateral hole, the ratio of Bₛ to B_{I} (Bₛ:B_{I}) is preferably more than 1:1 and not more than 1:1.5, 1:1.08 to 1.33, or 1:1.15 to 1.26, more preferably 1:1.15 to 1.3, or 1:1.2 to 1.3, and still more preferably 1: about 1.2. In the first embodiment, the laser beam L emitted from the beam rotator 12 is emitted in parallel with the central axis, and is made incident on the beam shaper 13 in parallel with the central axis, as described above. Thus, the incident beam diameter (B_{I}) can also be referred to as the outer peripheral diameter or outer diameter of the energy intensity distribution Brₐᵥₑ.

(3) Mirror 14, Focusing optical system 15, and XY Stage 16

The mirror 14 guides the laser beam L emitted from the beam shaper 13 to the focusing optical system 15. The mirror 14 need only be a member capable of guiding the laser beam L emitted from the beam shaper 13 to the focusing optical system 15, and may be a galvanometer scanner or the like. By using a galvanometer scanner as the mirror 14, it is possible to scan an irradiation position of the laser beam L on the workpiece T, and a region that can be processed with the laser beam L thus can be controlled as desired.

The focusing optical system 15 focuses the laser beam L guided by the mirror 14 onto the workpiece T. A condenser lens can be used as the focusing optical system 15. In the processing apparatus 100, the averaged energy intensity distribution Bₛᵣₐᵥₑ of the laser beam L emitted from the beam shaper 13 is as shown in FIG. 6C. The focusing optical system 15 focuses the laser beam L emitted from the beam shaper 13 onto the workpiece T, whereby a quadrilateral hole with four sharp corners can be formed on the IN-side surface of the workpiece owing to the action of the diffracted light components at the four points indicated by the arrows in FIG. 6C.

The XY stage 16 is configured such that the workpiece T can be mounted thereon, and is movable in the horizontal direction, i.e., movable on an XY plane.

In the first embodiment, the XY stage 16 is an optional component and not an essential component. When the processing apparatus 100 includes the XY stage 16, an irradiation position of the laser beam L on the workpiece T can be controlled by moving the workpiece T by the XY stage 16.

### (4) Effects of First Embodiment

In the processing apparatus 100 of the first embodiment, the beam rotator 12 emits laser beam L incident thereon after making it eccentric from the central axis of the beam shaper 13 and also causes the eccentric laser beam L to be incident on the beam rotator 13 in the state where the eccentric laser beam L has been rotated. Moreover, in the processing apparatus 100 of the first embodiment, a beam having a diameter larger than the standard incident beam diameter (Bₛ) set for the beam shaper 13 is made incident on the beam shaper 13.

Thus, in the laser processing apparatus 100, the incident beam diameter (B_{I}) can be made relatively large as compared with the incident beam diameter in a laser processing apparatus configured such that laser beam L generated by the laser oscillator 11 is directly incident on the beam shaper 13. As a result, the laser beam Lis incident on the out-of-boundary region of the beam shaper 13, whereby diffracted light components can be produced effectively.

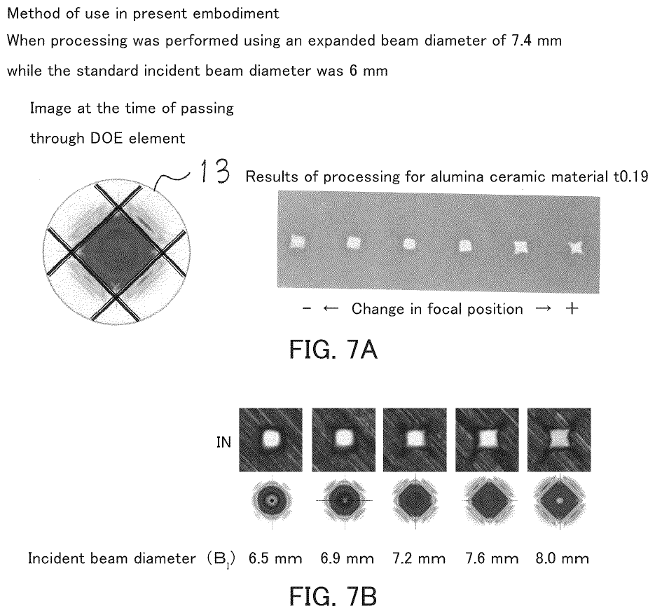

Then, the processing apparatus 100 can perform drilling using the laser beam L having high energy intensity at four corners owing to the action of these diffracted light components, whereby quadrilateral holes as shown in FIG. 7, i.e., quadrilateral holes with small R at the corners, can be formed.

FIG. 7A shows the result of drilling when, in the laser processing apparatus 100, laser beam having a diameter of 7.4 mm was made incident on the beam shaper 13 with the standard incident beam diameter (Bₛ) set to 6 mm. From the comparison with the results of drilling with the laser beam diameter equal to the incident beam diameter of 6 mm shown in FIG. 2B, it can be seen that the four corners are apparently sharp. In particular, as can be seen from the results of drilling shown in two rows from the right in FIG. 7A, in the laser processing apparatus 100, the hole formed by drilling can have sharper corners as the beam focal position moves toward+. In the laser processing apparatus 100, for example, a quadrilateral hole with extremely small R at the corners can be formed by scanning a beam with sharp corners along the X-axis direction and the Y-axis direction (orthogonal to the X-axis direction) on the surface of the workpiece T (XY plane) using the above-described galvanometer scanner or the like.

FIG. 7B shows the results of drilling quadrilateral holes of about 17 μm× about 17 μm using laser beam with different incident beam diameters (B_{I}), namely, 6.5 mm, 6.9 mm, 7.2 mm, 7.6 mm, and 8.0 mm. As can be seen from FIG. 7B, the four corners of the thus-formed holes each had smaller R than those of the holes of the conventional example shown in FIG. 2B, and when the incident beam diameter (B_{I}) was 7.2 mm, an ideal quadrilateral hole, i.e., a quadrilateral hole with extremely small R at the corners, could be formed.

### Second Embodiment

In the first embodiment, quadrilateral holes with sharp corners were drilled utilizing diffracted light components of laser beam L passing through the out-of-boundary region of the beam shaper 13. It is to be noted that, as can be seen from FIG. 7B, as the incident beam diameter increases, the action of the diffracted light components becomes stronger and the four corners tend to be somewhat too sharp. Thus, in the second embodiment, a laser processing apparatus capable of correcting excessively sharpened corners will be described.

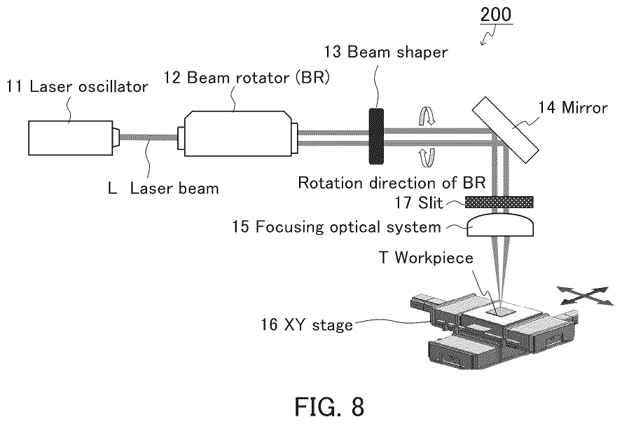

FIG. 8 shows an example of the configuration of a laser processing apparatus 200 of the second embodiment. As shown in FIG. 8, the laser processing apparatus 200 of the second embodiment further includes a slit 17 in addition to the structural components of the laser processing apparatus 100 of the first embodiment. Except for this, the laser processing apparatus 200 of the second embodiment has the same configuration as the laser processing apparatus 100 of the first embodiment, and the description on the configuration of the laser processing apparatus 100 also applies to the laser processing apparatus 200.

The slit 17 shapes laser beam L into a quadrilateral shape. The slit 17 is a plate-like member provided with a quadrilateral opening. The slit 17 allows the laser beam L to pass through an opening region provided at a central portion thereof, whereas it does not allow the laser beam L to pass therethrough outside the opening region provided at the central portion.

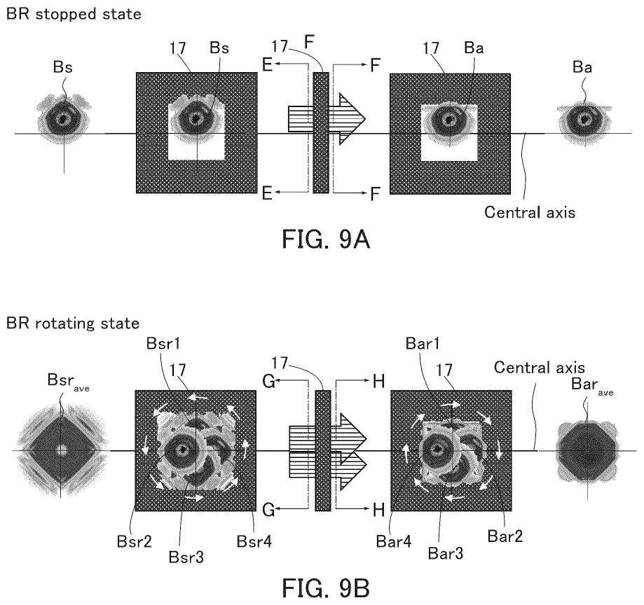

The function of the slit 17 will be described more specifically with reference to FIG. 9. FIG. 9A shows the state where a rotation mechanism 123 is temporarily stopped (BR stopped state), and FIG. 9B shows the state where the rotation mechanism 123 is rotating (BR rotating state), which corresponds to the state in normal use.

In FIG. 9A, Bs shows an example of the energy intensity distribution of the laser beam L (beam) viewed along arrows E-E, and Ba shows an example of the energy intensity distribution of the laser beam L (beam) viewed along arrows F-F. In FIG. 9B, Bsr1 to Bsr4 each show an example of the energy intensity distribution of the laser beam L (beam) viewed along arrows G-G, and Bsrₐᵥₑ shows an example of the averaged energy intensity distribution of the laser beam L (beam) viewed along arrows G-G. Bar1 to Bar4 each show an example of the energy intensity distribution of the laser beam L (beam) viewed along arrows H-H, and Barₐᵥₑ shows an example of the averaged energy intensity distribution of the laser beam L (beam) viewed along arrows H-H.

In FIGS. 9A and 9B, arrows passing through the slit 17 illustrate the movement of the laser beam L. White arrows in FIG. 9B indicate the rotation direction of the laser beam L. In the laser processing apparatus 200 of the second embodiment, the slit 17 has an opening for converting the shape of the beam of the laser beam L into a quadrilateral shape.

As shown in FIG. 9A, in the BR stopped state, the laser beam L emitted from the beam rotator 13 is incident on the slit 17 at a position eccentric from and in parallel with the central axis of the slit 17. Then, the beam shape of the laser beam L is converted by the opening of the slit 17.

Specifically, in the laser processing apparatus 200 of the second embodiment, the slit 17 has a quadrilateral opening region at a central portion thereof, and the slit 17 allows the laser beam L to pass through the opening region, whereas it does not allow the laser beam L to pass therethrough outside the opening region. Accordingly, in the energy intensity distribution Ba of the laser beam L, the energy intensity outside the opening region has been converted to one at which processing is substantially impossible, as compared to the energy intensity distribution Bs of the laser beam L. With this configuration, the slit 17 can convert the shape of the beam of the laser beam L, in particular, the shape of a region having energy intensity capable of processing a workpiece T, so as to constitute part of a desired shape.

Next, as shown in FIG. 9B, in the BR rotating state, wedge prisms 121a and 121b rotate in synchronization with each other along with the rotation of a rotation mechanism 123. With this configuration, the energy intensity distribution of the laser beam L after being emitted from a beam shaper 13 rotates at a position eccentric from the central axis of the slit 17.

That is, at an initial position at the start of rotation shown in FIG. 9A, the energy intensity distribution of the laser beam L after being emitted is Bsr1. Then, along with the rotation of the rotation mechanism 123 and the wedge prisms 121a and 121b, the energy intensity distribution of the laser beam L after being emitted changes its position continuously from Bsr1 to Bsr2, Bsr3, Bsr4, and Bsr1 about the central axis. Accordingly, the averaged energy intensity distribution obtained by averaging the energy intensity distributions of the laser beam L after being emitted from the beam shaper 13 in the BR rotating state is BSrₐᵥₑ.

When the laser beam L incident from the beam shaper 13 passes through the slit 17, the laser beam L can pass through the opening region (quadrilateral shape) in the central portion of the slit 17, whereas the laser beam L cannot pass through the slit 17 outside the opening region (quadrilateral shape) in the central portion. Accordingly, the energy intensity distributions Bsr1, Bsr2, Bsr3, and Bsr4 of the incident laser beam L are converted to the energy intensity distributions Bar1, Bar2, Bar3, and Bar4, respectively, after passing through the slit 17.

As a result, the averaged energy intensity distribution obtained by averaging the energy intensity distributions of the laser beam L emitted from the slit 17 in the BR rotating state is Barₐᵥₑ, and the beam shape of the laser beam L, in particular, the shape of a region having energy intensity capable of processing the workpiece T, is converted so as to constitute a quadrilateral shape as the desired shape.

Then, the thus-shaped laser beam L is emitted from the slit 17. The laser beam L emitted from the slit 17 is focused on the workpiece T by a focusing optical system 15. In this manner, the laser processing apparatus 200 of the second embodiment can form a shape that is similar to the outer peripheral shape of the energy intensity distribution Barₐᵥₑ on an irradiation surface, i.e., an IN-side surface, of the workpiece T.

The laser processing apparatus 200 of the second embodiment uses the beam shaper 13 that converts the beam mode (beam profile) of the laser beam L and the slit 17 that converts the beam shape in combination, whereby the outer peripheral shape of the beam of the laser beam L can be made closer to a desired shape, i.e., a more accurate shape. Thus, the laser processing apparatus 200 of the second embodiment enables micromachining with higher accuracy in shape with respect to the IN-side surface of the workpiece T.

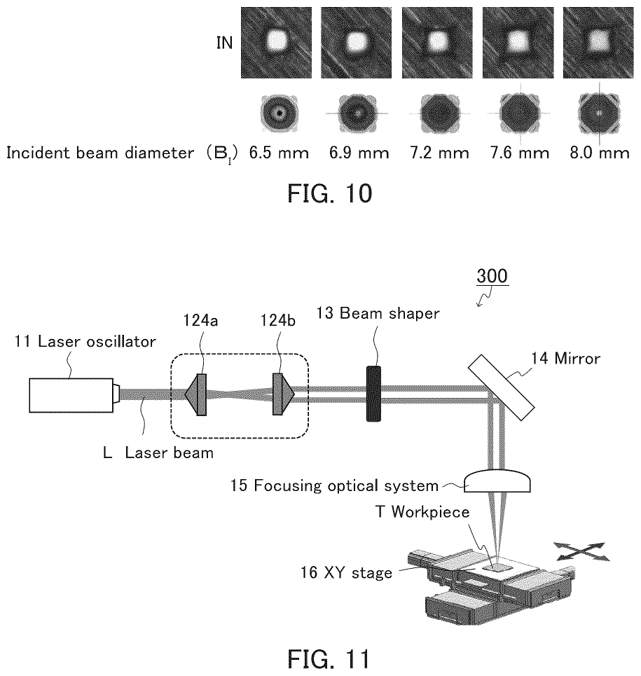

FIG. 10 shows the results of drilling using the laser processing apparatus 200. FIG. 10 shows the results of drilling quadrilateral holes of about 17 μm× about 17 μm using laser beam with different incident beam diameters (B_{I}), namely, 6.5 mm, 6.9 mm, 7.2 mm, 7.6 mm, and 8.0 mm. From the comparison with FIG. 7B showing the results in the first embodiment, it can be seen that the second embodiment corrected the excessively sharpened four corners and enabled drilling of quadrilateral holes with higher accuracy in shape.

In the laser processing apparatus 200 of the second embodiment, the slit 17 is arranged between the mirror 14 and the focusing optical system 15. It is to be noted, however, that the position of the slit 17 is not limited thereto and may be at any position between the beam shaper 13 and the workpiece T.

Although the desired shape is a quadrilateral shape in the laser processing apparatus 200 of the second embodiment, the desired shape may be any shape, and specific examples thereof include the above-described polygonal shapes: circular shapes such as a perfect circle and ovals:

and shapes combining these shapes.

### Third Embodiment

Next, another configuration will be described, which enables effective production of diffracted light components without using a beam rotator.

FIG. 11 shows an example of the configuration of a laser processing apparatus 300 of the third embodiment. As shown in FIG. 11, the laser processing apparatus 300 of the third embodiment includes axicon lenses 124a and 124b as beam conversion units, instead of the beam rotator 12 in the configuration of the laser processing apparatus 100 of the first embodiment. The axicon lenses 124a and 124b are arranged such that the conical end face of the axicon lens 124a faces a laser oscillator 11 and the conical end face of the axicon lens 124b faces a beam shaper 13. The central axis of laser beam L generated by the laser oscillator 11, the central axes of the axicon lenses 124a and 124b, and the central axis of the beam shaper 13 extend coaxially. Except for the above, the laser processing apparatus 300 of the third embodiment has the same configuration as the laser processing apparatus 100 of the first embodiment, and the description on the configuration of the laser processing apparatus 100 also applies to the laser processing apparatus 300.

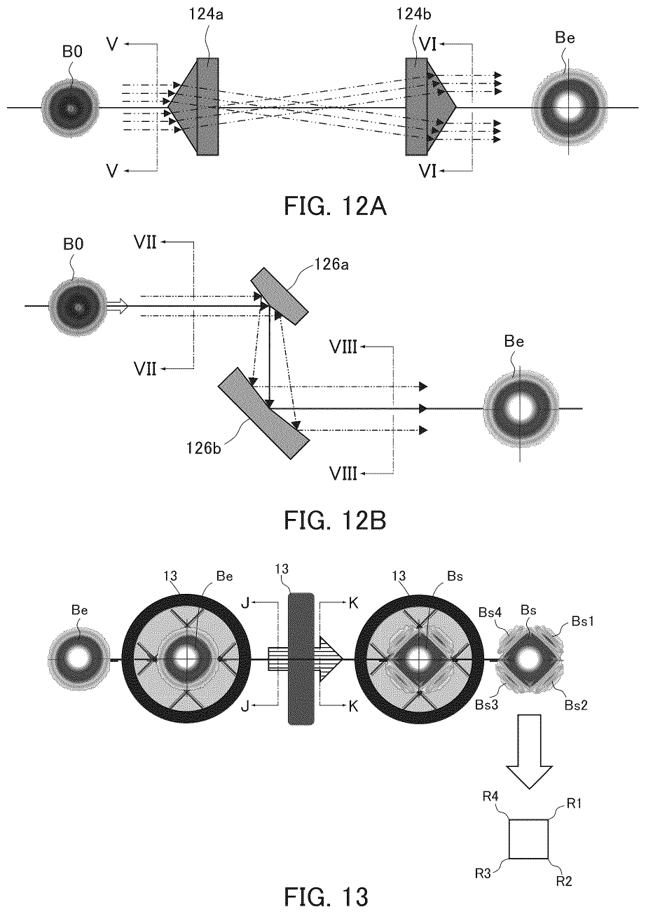

The function of the axicon lenses 124a and 124b will be described more specifically with reference to FIG. 12A. In FIG. 12A, B0 shows an example of the energy intensity distribution of the laser beam L (beam) viewed along arrows V—V, and Be shows an example of the energy intensity distribution of the laser beam L (beam) viewed along arrows VI-VI. Double-dot-dashed lines in FIG. 12A illustrate the movement of the laser beam L.

As shown in FIG. 12A, the laser beam L emitted from the laser oscillator 11 is incident on the conical end face of the axicon lens 124a along the central axes of the axicon lenses 124a and 124b. At this time, the laser beam L is deflected at a predetermined angle in accordance with the inclination of the conical end face of the axicon lens 124a. Subsequently, the laser beam L is emitted from the flat end face of the axicon lens 124a and is incident on the flat end face of the axicon lens 124b. Then, the laser beam L is emitted from the conical end face of the axicon lens 124b. At this time, the laser beam Lis deflected at a predetermined angle in accordance with the inclination of the conical end face of the axicon lens 124a and becomes in parallel with the central axis.

Accordingly, the energy intensity distribution Be of the laser beam L after being emitted from the axicon lens 124b is in the form of an annular ring, as compared with the energy intensity distribution B0 of the laser beam L before being incident on the axicon lens 124a.

The distance between the axicon lenses 124a and 124b can be set according to a desired size (diameter) of the annular ring. More specifically, the distance between the axicon lenses 124a and 124b can be set such that the inner diameter (Ri) and the outer diameter (Ro) of the annular ring and the standard incident beam diameter (Bₛ) of the beam shaper 13 satisfy Ri≤Bₛ<Ro. Regarding the ratio (Ro:Bₛ) between the outer diameter (Ro) of the annular ring and the standard incident beam diameter (Bₛ), reference can be made to the above description on the ratio (Bₛ:B_{I}), in which the term “incident beam diameter (B_{I})” should be considered to be replaced with the term “outer diameter of the annular ring (Ro)”.

As described in the first embodiment, the beam shaper 13 is a diffractive optical element (DOE)—type beam shaper that converts the outer peripheral shape of the beam of laser beam L into a quadrilateral shape. In FIG. 13, Be shows an example of the energy intensity distribution of the laser beam L (beam) viewed along arrows J-J, and Bₛ shows an example of the energy intensity distribution of the laser beam L (beam) viewed along arrows K—K. In FIG. 13, an arrow passing through the beam shaper 13 illustrates the movement of the laser beam L.

As shown in FIG. 13, the laser beam L emitted from the axicon lens 124b is incident on the beam shaper 13 in the form of an annular beam. Then, the energy intensity distribution of the laser beam L is converted by a diffractive optical element provided inside the beam shaper 13.

Specifically, as in the first embodiment, the energy intensity of the laser beam passing through a region of a quadrilateral shape (lattice pattern) in a central portion of the beam shaper 13 (in-boundary region) is maintained or made uniform, whereas the energy intensity of the laser beam passing through or coming into contact with a region outside the quadrilateral shape (lattice pattern) in the central portion (out-of-boundary region) is enhanced.

The outer diameter (Ro) of the annular beam incident on the beam shaper 13 is larger than the standard incident beam diameter (Bₛ). Thus, diffracted light components are generated at the boundary of the beam shaper 13, and the energy intensities at Bs1, Bs2, Bs3, and Bs4 shown in FIG. 13 are enhanced by these diffracted light components. The diffracted light components at these four points indicated by the arrows serve as components that sharpen four corners when drilling a quadrilateral hole in a workpiece T. Specifically, when drilling the quadrilateral hole, the diffracted light components at Bs1 act to sharpen a corner R1, the diffracted light components at Bs2 act to sharpen a corner R2, the diffracted light components at Bsr3 act to sharpen a corner R3, and the diffracted light components at Bsr4 act to sharpen a corner R4.

The thus-shaped laser beam Lis emitted from the beam shaper 13. The laser beam L emitted from the beam shaper 13 is focused onto the workpiece T by the focusing optical system 15. In this manner, the laser processing apparatus 300 of the third embodiment can form a quadrilateral hole with sharp corners, i.e., a quadrilateral hole with small R at the corners, on the irradiation-side surface, i.e., the IN-side surface, of the workpiece T.

The laser processing apparatus 300 of the third embodiment can effectively produce diffracted light components using only an optical system without using a rotation mechanism. Thus, according to the laser processing apparatus 300 of the third embodiment, a processing apparatus that enables micromachining with higher accuracy in shape with respect to the IN-side surface of a workpiece T can be manufactured at lower cost.

In the laser processing apparatus 300 of the third embodiment, the axicon lenses 124a and 124b are arranged such that their flat end faces face each other. It is to be noted, however, that the present disclosure is not limited thereto, and the axicon lenses 124a and 124b may be arranged such that their conical end faces face each other. Also, instead of the axicon lenses 124a and 124b, a convex conical mirror 126a and a concave conical mirror 126b may be used in combination, as shown in FIG. 12B. In this case, by adjusting the distance between the convex conical mirror 126a and the concave conical mirror 126b, the size of the annular beam (the size of the ring of the energy intensity distribution Be) can be adjusted. A concave conical mirror may be used instead of the convex conical mirror 126a.

### Fourth Embodiment

In the first to third embodiments above, laser processing apparatuses capable of, in drilling of a quadrilateral hole, sharpening four corners of the hole on the irradiated side, i.e., IN side, has been described. The fourth embodiment will describe a laser processing apparatus capable of not only sharpening four corners on the IN side but also forming an accurate quadrilateral hole on the rear surface, i.e., on the OUT side.

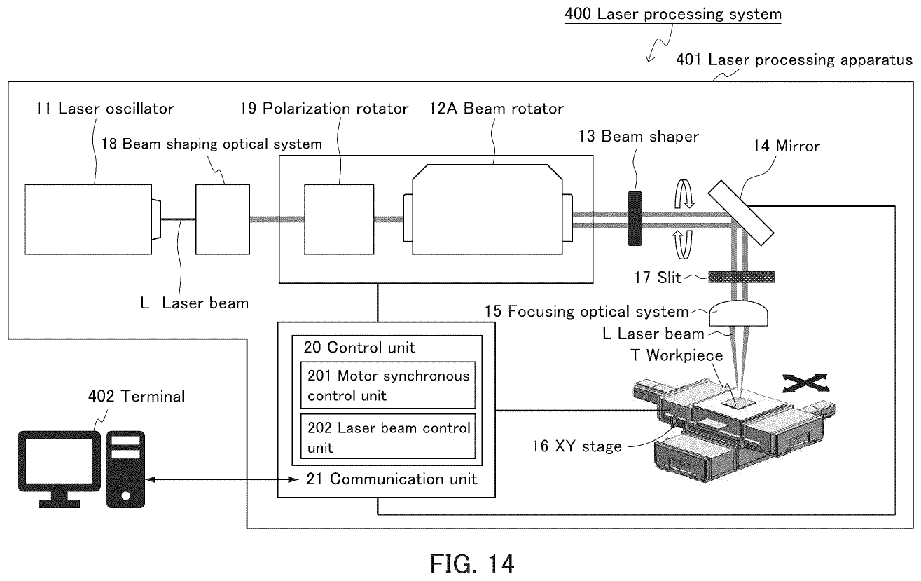

FIGS. 14 to 17 show an example of the configuration of a laser processing system 400 of the fourth embodiment including a laser processing apparatus 401 and a terminal 402.

As shown in FIG. 14, the laser processing system 400 includes the laser processing apparatus 401 and the terminal 402. The laser processing apparatus 401 and the terminal 402 are capable of communicating with each other. The laser processing apparatus 401 includes, in addition to the structural components of the laser processing apparatus 100 of the first embodiment, a slit 17, a beam shaping optical system 18 (beam expander), a polarization rotator 19, a control unit 20, and a communication unit 21 as main structural components.

The control unit 20 includes a motor synchronous control unit 201 and a laser beam control unit 202. The motor synchronous control unit 201 synchronously controls the rotation of a first rotation mechanism 193 of the polarization rotator 19 and a second rotation mechanism 123A of a beam rotator 12A.

The driving force for rotating the first rotation mechanism 193 is supplied by a first servo motor 194, which is a first rotation actuator. The driving force for rotating the second rotation mechanism 123A is supplied by a second servo motor 124, which is a second rotation actuator.

The laser beam control unit 202 controls at least one of a mirror 14 and an XY stage 16 to control the scanning trajectory of laser beam toward a workpiece T.

The communication unit 21 is capable of communicating with the terminal 402, and control information from the terminal 402 is transmitted to the control unit 20 via the communication unit 21. Then, according to the control information, the motor synchronous control unit 201 and the laser beam control unit 202 control the respective components of the laser processing apparatus 401, such as the polarization rotator 19, the beam rotator 12A, the mirror 14, the XY stage 16, the first rotation actuator 194, and the second rotation actuator 124.

The laser processing apparatus 401 includes the beam rotator 12A instead of the beam rotator 12 in the laser processing apparatus 100 of the first embodiment. The laser beam L generated by a laser oscillator 11 is applied to the workpiece T placed on the XY stage 16 after passing through the beam shaping optical system 18, the polarization rotator 19, the beam rotator 12A, a beam shaper 13, the mirror 14 (galvanometer scanner), and a focusing optical system 15. The fourth embodiment describes the case where the polarized pattern of the laser beam Lis linear polarization as an illustrative example.

The beam shaper 13 has the same function as the beam shaper 13 of the first embodiment. That is, the beam shaper 13 converts the energy intensity distribution of the laser beam L incident from the beam rotator 12A, thereby allowing four corners of a quadrilateral hole on the IN side to be sharpened.

The terminal 402 need only be capable of creating control information for controlling the processing apparatus 401, and for example, an arithmetic unit such as a personal computer (PC), a server, a smartphone, or a tablet can be used as the terminal 402. Communication between the communication unit 21 of the processing apparatus 401 and the terminal 402 may be either wired or wireless. Also, communication between the communication unit 21 of the processing apparatus 401 and the terminal 402 may be either direct communication between the communication unit 21 and the terminal 402 or may be communication between them via a telecommunication network. The telecommunication network may be the Internet, an intranet, a LAN, or the like.

The beam shaping optical system 18 is an optical system that converts the beam shape and the beam diameter of laser beam L incident thereon to a desired beam shape and a desired beam diameter, and includes the combination of a beam expander and an aperture. The laser beam L emitted from the laser oscillator 11 is incident on the beam shaping optical system 18. The incident laser beam L is converted so as to have a desired beam shape and a desired diameter by the beam shaping optical system 18, and is then emitted from the beam shaping optical system 18.

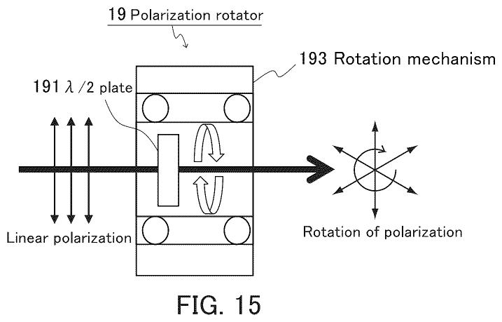

FIG. 15 shows the configuration and the function of the polarization rotator 19. As shown in FIG. 15, a wave plate such as a λ/2 plate 191 is arranged in the polarization rotator 19. The wave plate (λ/2 plate 191) is rotatable by the first rotation mechanism 193. Although the λ/2 plate is used as the wave plate, other wave plates such as a λ/4 plate are also applicable. The laser beam L shaped by the beam shaping optical system 18 is in a linearly polarized state. The polarization rotator 19 includes the rotatable λ/2 plate 191. Accordingly, when the laser beam L passes through the polarization rotator 19, the polarization direction of the linearly polarized light rotates in accordance with the position of the λ/2 plate 191. Then, the laser beam L whose polarization direction has been converted is emitted from the polarization rotator 19.

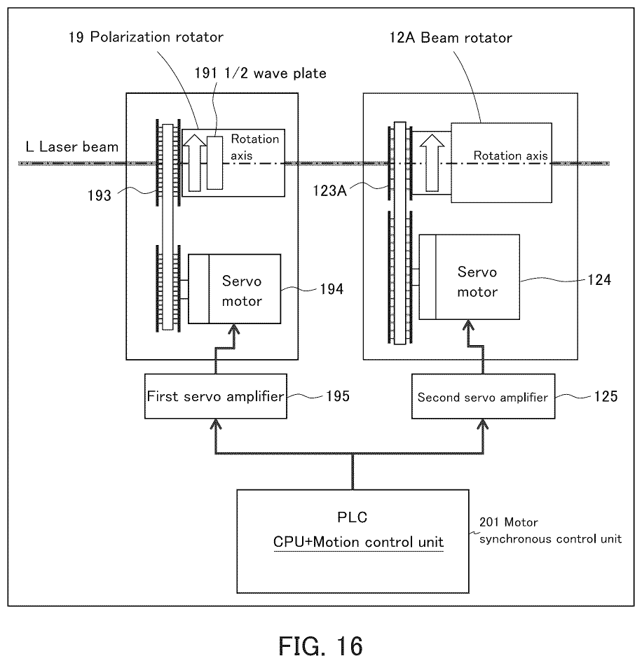

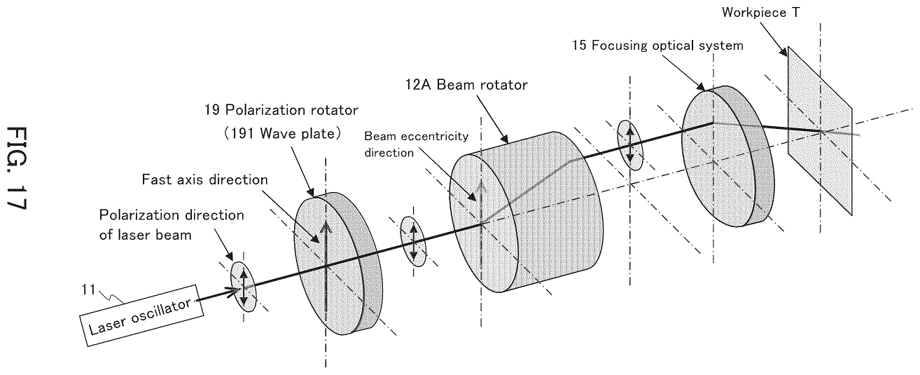

Next, with reference to FIG. 16, the function of the motor synchronous control unit 201 of the control unit 20 and synchronous control of the polarization rotator 19 and the beam rotator 12A will be described. As shown in FIG. 16, the motor synchronous control unit 201 synchronously controls the rotation of the first rotation mechanism 193 of the polarization rotator 19 and the second rotation mechanism 123A of the beam rotator 12A. The driving forces for rotating the first rotation mechanism 193 and the second rotation mechanism 123A are supplied by the rotation actuators, namely, the first servo motor 194 (first rotation actuator) and the second servo motor 124 (second rotation actuator), respectively. Instead of the servo motors, any motors capable of rotating target objects may be used, for example. The rotational driving of the first servo motor 194 and the rotational driving of the second servo motor 124 are controlled by a first servo amplifier 195 and a second servo amplifier 125, respectively.

As shown in FIG. 16, the motor synchronous control unit 201 includes a programmable logic controller (PLC). The PLC includes a CPU (a central processing unit and a motion control unit). The first servo motor 194 of the polarization rotator 19 is connected to the first servo amplifier 195 and the first rotation mechanism 193. The second servo motor 124 (second rotation actuator) of the beam rotator 12A is connected to the second servo amplifier 125 and the second rotation mechanism 123A. The rotational speeds of the first servo motor 194 and the second servo motor 124 and the rotational phase difference between them are controlled in response to control signals transmitted from the PLC to the first servo amplifier 195 and the second servo amplifier 125. The polarization rotator 19 and the beam rotator 12A are not necessarily driven individually by different motors, and may be driven by a single motor using, for example, two rotation actuators having a gear structure.

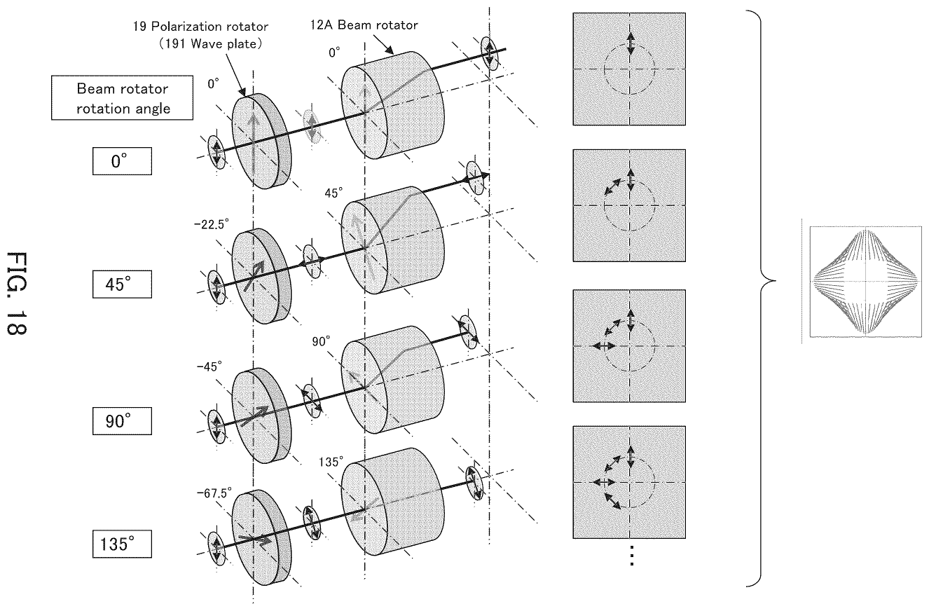

The control of the rotational phase difference between the polarization rotator 19 and the beam rotator 12A will be described with reference to FIG. 17. In FIG. 17, the beam shaper 13 is omitted.

First, a first initial position (0 degrees) of the wave plate 191 is defined as a rotation angle at which the polarization direction of laser beam L coincides with the fast axis direction of the wave plate 191. A second initial position (0 degrees) of the beam rotator 12A is defined as a rotation angle at which the polarization direction of the laser beam L coincides with the beam eccentricity direction of the beam rotator 12A. The rotational phase difference is defined as the phase difference between the first initial position and the second initial position. In this case, the relationship among the rotation angle (θPR) of the polarization rotator 19, the rotation angle (OBR) of the beam rotator 12A, the rotational speed ratio (X/Y) between the polarization rotator 19 and the beam rotator 12A, and the rotational phase difference (θ0) is expressed by the following equation (1).

In the processing apparatus 401, the rotational phase difference between the polarization rotator 19 and the beam rotator 12A may be reset to “0” degrees, for example, when the apparatus is turned on or off or before starting a rotational operation.

$$θ PR = θ BR \times X / Y + θ0 \qquad ( 1 )$$

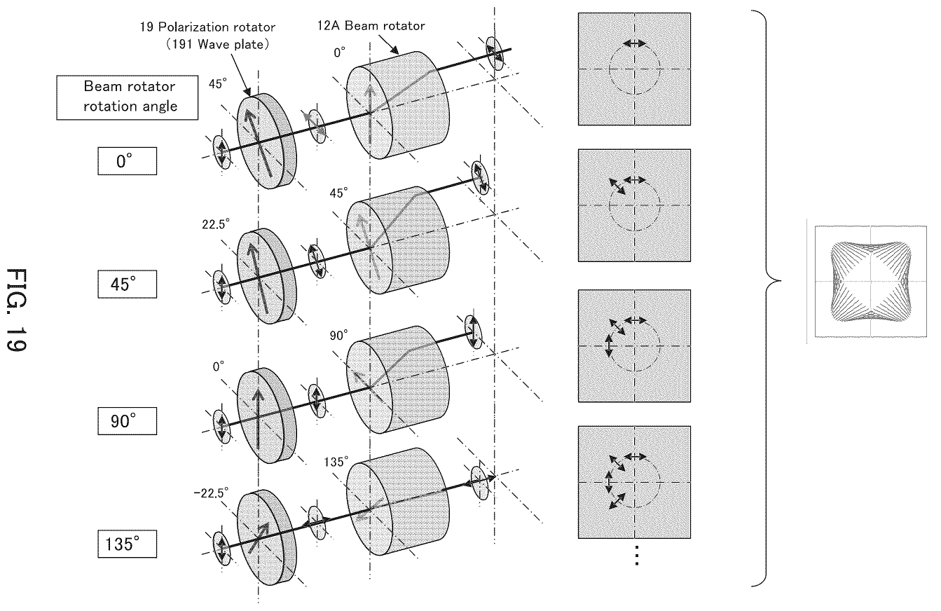

Next, with reference to FIGS. 18 to 20, the relationship between the rotational speed ratio (X:Y) of the rotational speed (X) of the polarization rotator 19, which is the rotational speed (X) of the first rotation mechanism 193, to the rotational speed (Y) of the beam rotator 12A, which is the rotational speed (Y) of the second rotation mechanism 123A, and the polarized pattern of the laser beam L will be described.

In the following description, when the rotational speed ratio (X:Y) is plus (+): plus (+), it means that the rotation direction of the first rotation mechanism 193 is the same as the rotation direction of the second rotation mechanism 123A. On the other hand, when the rotational speed ratio (X:Y) is minus (−):plus (+), it means that the rotation direction of the first rotation mechanism 193 is opposite to the rotation direction of the second rotation mechanism 123A. The plus and minus may be defined freely. For example, counterclockwise (left-handed) rotation may be defined as plus and clockwise (right-handed) rotation may be defined as minus, and vice versa. In the following description, the rotation angle refers to the angle of the wave plate 191 with respect to the fast axis direction and the angle of the beam rotator 12A with respect to the beam eccentricity direction.

FIG. 18 shows schematic diagrams illustrating the relationship between the fast axis direction of the wave plate 191 and the beam eccentricity direction of the beam rotator 12A when the rotational speed ratio (X:Y) of the rotational speed (X) of the polarization rotator 19 (wave plate 191, λ/2 plate) to the rotational speed of the beam rotator 12A (Y) is −0.5:1 and the rotational phase difference (degrees) is controlled to be “0” degrees. The polarization state of laser beam in this case exhibits a quadrilateral polarized pattern having a rhombic shape as shown on the right in FIG. 18.

When the rotation angle of the beam rotator 12A is 0 degrees, the rotation angle of the wave plate 191 is also 0 degrees. When the beam rotator 12A rotates counterclockwise (leftward) to a rotation angle of 45 degrees, the wave plate 191 rotates clockwise (rightward) to a rotation angle of −22.5 degrees. When the angular difference between the fast axis direction of the λ/2 plate and the polarization direction of the incident beam is 0, the polarization direction of the beam that has passed through the λ/2 plate is 20.

Thus, when the rotation angle of the wave plate is −22.5 degrees, the polarization direction of the beam is −45 degrees, and this polarization direction is orthogonal to the eccentricity direction of the beam rotator 12A. When the beam rotator 12A rotates counterclockwise (leftward) to a rotation angle of 90 degrees, the wave plate 191 rotates clockwise (rightward) to a rotation angle of −45 degrees, and the polarization direction of the beam at this time is −90 degrees. When the beam rotator 12A rotates counterclockwise (leftward) to a rotation angle of 195 degrees, the wave plate 191 rotates clockwise (rightward) to a rotation angle of −67.5 degrees, and the polarization direction of the beam at this time is −195 degrees. As described above, the processing apparatus 401 causes the beam to be in a specific polarization direction with respect to the angle by which the beam is rotated, whereby the rotating beam as a whole can form a quadrangular polarized pattern having a rhombic shape.

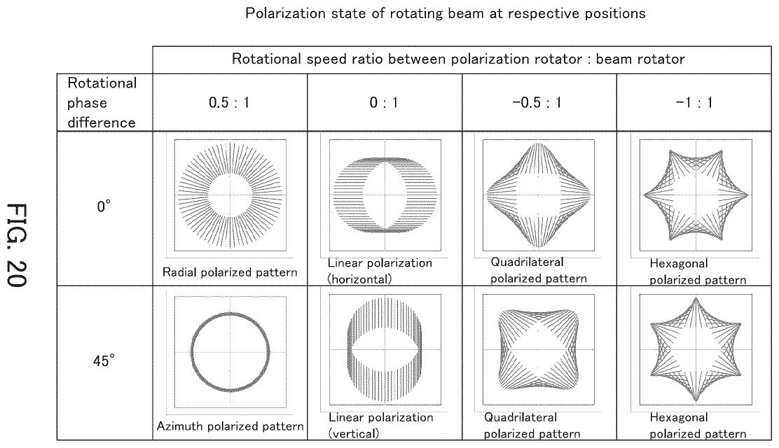

FIG. 19 shows schematic diagrams illustrating the relationship between the fast axis direction of the wave plate 191 and the beam eccentricity direction of the beam rotator 12A when the rotational speed ratio (X:Y) of the rotational speed (X) of the polarization rotator 19 (wave plate 191, λ/2 plate) to the rotational speed of the beam rotator 12A (Y) is −0.5:1 and the rotational phase difference (degrees) is controlled to be “45 degrees”. The polarization state of laser beam in this case exhibits a quadrilateral polarized pattern having a square shape as shown on the right in FIG. 19.

First, when the rotation angle of the beam rotator 12A is 0 degrees, the rotation angle of the wave plate 191 is 45 degrees, and the polarization direction of the beam at this time is 90 degrees. When the beam rotator 12A rotates counterclockwise (leftward) to a rotation angle of 45 degrees, the wave plate 191 rotates clockwise (rightward) to a rotation angle of 22.5 degrees, and the polarization direction of the beam at this time is 45 degrees. When the beam rotator 12A rotates counterclockwise (leftward) to a rotation angle of 90 degrees, the wave plate 191 rotates clockwise (rightward) to a rotation angle of 0 degrees, and the polarization direction of the beam at this time is also 0 degrees. When the beam rotator 12A rotates counterclockwise (leftward) to a rotation angle of 195 degrees, the wave plate 191 rotates clockwise (rightward) to a rotation angle of −22.5 degrees, and the polarization direction of the beam at this time is −45 degrees. By providing a rotational phase difference in the above-described manner, the processing apparatus 401 can form a quadrilateral polarized pattern having a square shape by rotating the polarized pattern oriented (45 degrees) in the direction forming a rhombus shape in FIG. 16.

FIG. 20 shows the polarization states of laser beam when the rotational speed ratio (X:Y) of the rotational speed (X) of the polarization rotator 19 (wave plate 191, λ/2 plate) to the rotational speed (Y) of the beam rotator 12A and the rotational phase difference (degrees) are controlled. First, in the case where the rotational speed ratio is 0.5:1, a radial polarized pattern is formed when the rotational phase difference is 0 degrees and an azimuth polarized pattern is formed when the rotational phase difference is 45 degrees. In the case where the rotational speed ratio is 0:1, a linear polarization (horizontal) is formed when the rotational phase difference is 0 degrees and linear polarization (vertical) is formed when the rotational phase difference is 45 degrees. In the case where the rotational speed ratio is −0.5:1, a quadrilateral polarized pattern having a rhombic shape is formed when the rotational phase difference is 0 degrees and a quadrilateral polarized pattern having a square shape is formed when the rotational phase difference is 45 degrees. In the case where the rotational speed ratio is −1:1, a hexagonal polarized pattern having vertexes on the left and right is formed when the rotational phase difference is 0 degrees and a hexagonal polarized pattern having vertexes on the top and bottom is formed when the rotational phase difference is 45 degrees.

It should be noted that the polarization states shown in FIG. 20 are merely illustrative, and by changing the rotational speed ratio and the rotational phase difference between the polarization rotator 19 and beam rotator 12A, it is possible to set laser beam in various polarization states.

The processing system 400 of the fourth embodiment can provide laser beam Lin various polarization states by synchronously controlling the rotation of the polarization rotator 19 and the beam rotator 12A, thereby enabling more accurate micromachining than in conventional laser processing. In addition, according to the processing apparatus 401 of the fourth embodiment, laser beam L that is in a desired polarization state can be shaped by the beam shaper 13 so as to be closer to a desired shape, whereby it becomes possible to perform micromachining with higher accuracy in shape.

Further, the laser processing apparatus 401 of the fourth embodiment enables micromachining with high accuracy in shape on an OUT-side surface.

Conventional methods for changing the polarization state of laser beam L include a method using of a polarization converting element and a method using a liquid crystal axisymmetric converter. However, the method using a polarization converting element has problems in that a wave plate is expensive and the polarization state is fixed and cannot be changed. Also, the method using a liquid crystal axisymmetric converter has problems in that the transmittance of laser beam L is low and the laser damage threshold is low.

In contrast to these techniques, the laser processing apparatus 401 of the fourth embodiment, which can provide laser beam L in various polarization states enabling accurate precision machining by synchronously controlling the rotation of the polarization rotator 19 and the beam rotator 12A, is low cost and does not have a problem of transmittance of laser beam or cause a problem of laser damage threshold.

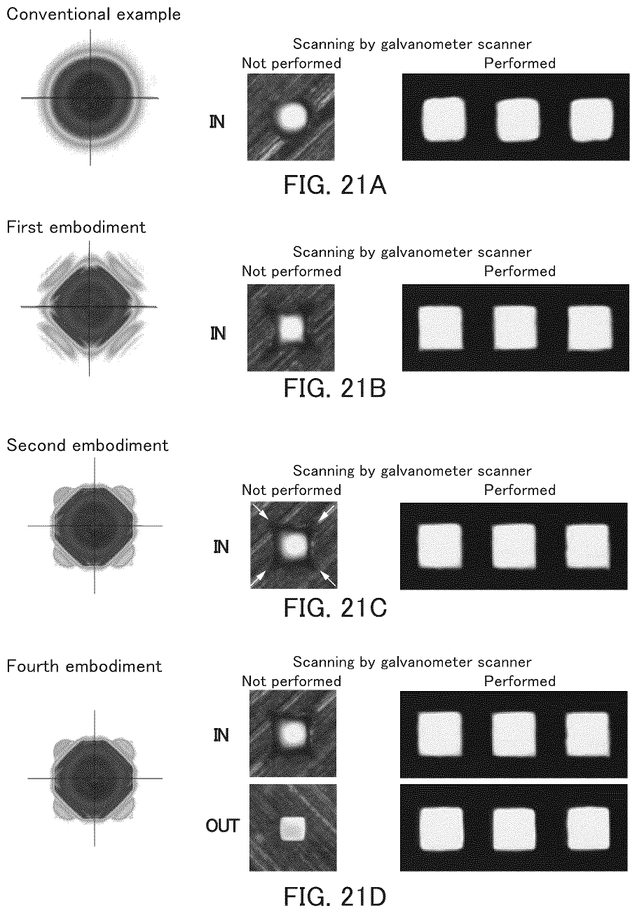

Next, results of actual drilling will be described with reference to FIG. 21.

FIG. 21A shows a conventional example in which the beam shaper 13 was not used. A conventional processing apparatus was used to perform processing for forming a quadrilateral hole of about 17 μm×about 17 μm on a silicon nitride plate (0.25 mm thick). Also, in FIG. 21A, quadrilateral holes of about 29 μm×about 29 μm were drilled using the conventional processing apparatus and a galvanometer scanner. As a result, the quadrilateral holes on the IN-side surface had rounded corners.

In FIG. 21B, the laser processing apparatus 100 of the first embodiment was used to drill a quadrilateral hole of about 17 μm×about 17 μm in the above-described plate. Also, in FIG. 21B, quadrilateral holes of 29 μm×about 29 μm were drilled using the laser processing apparatus 100 in which a galvanometer scanner was used. As the beam shaper 13, a diffractive optical element-type beam shaper with a standard incident beam diameter (Bₛ) of 6 mm was used, as already described above. As a result, the roundness of the corners of the quadrilateral holes was no longer observed on the IN-side surface, and the quadrilateral holes were formed accurately.

In FIG. 21C, the laser processing apparatus 200 of the second embodiment was used to form a quadrilateral hole of about 17 μm×about 17 μm in the above-described plate. Also, in FIG. 21C, quadrilateral holes of 29 μm×about 29 μm were drilled using the laser processing apparatus 200 in which a galvanometer scanner was used. As a result, on the IN-side surface, the roundness of the corners of the quadrilateral shape was no longer observed, and the quadrilateral holes were formed accurately. Moreover, according to the second embodiment, as indicated by arrows in FIG. 21C, elongation of sharp machining marks observed at the corners on the IN-side surface in the first embodiment could be reduced by the slit 17.

In FIG. 21D, the processing system 400 of the fourth embodiment was used, the rotational speed ratio (X:Y) between the polarization rotator 19 and the beam rotator 12A was set to −0.5:1, and the rotational phase difference between the polarization rotator 19 and the beam rotator 12A was set to 45 degrees. Then, quadrilateral holes of about 17 μm× about 17 μm were drilled in the above-described plate. Also, in FIG. 21D, scanning was performed using a galvanometer scanner to drill quadrilateral holes of about 29 μm× about 29 μm. The incident beam diameter (B_{I}) of laser beam was set to 7.2 mm. As a result, on both the IN-side surface and the OUT-side surface, the quadrilateral holes were formed accurately.

From these results, it was found that, by making laser beam L eccentric by the beam rotator 12 and then making the laser beam incident on the beam shaper 13, it becomes possible to perform micromachining with higher accuracy with respect to the IN-side surface of a workpiece T. It was also found that, by using the apparatus in combination with a slit having a desired shape, it becomes possible to perform micromachining with still higher accuracy with respect to the IN-side surface of the workpiece T. Still further, it was also confirmed that accurate processing also can be performed with respect to the OUT-side surface.

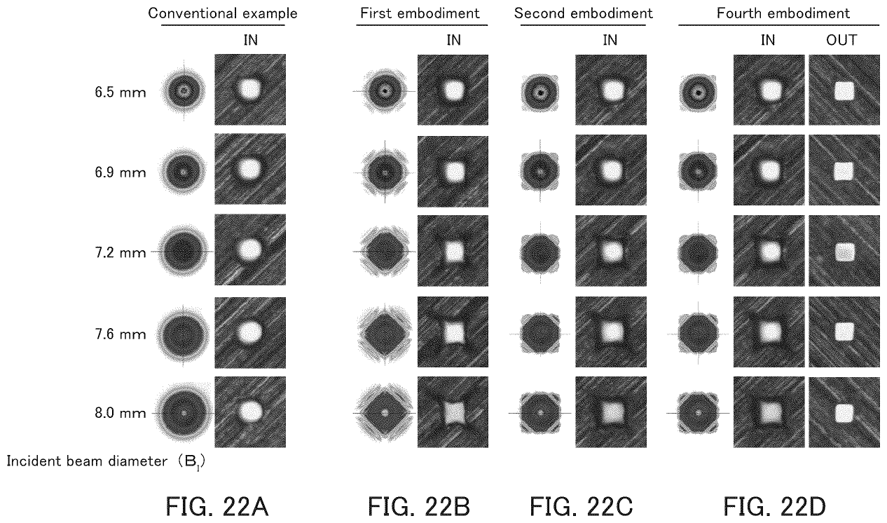

Subsequently, with reference to FIG. 22, the results of drilling using laser beam with different incident beam diameters (B_{I}), namely, 6.5 mm, 6.9 mm, 7.2 mm, 7.6 mm, and 8.0 mm, will be described. The drilling was performed without using the galvanometer scanner. FIG. 22 shows photographs showing the energy intensity distribution of laser beam L applied to the above-described plates and quadrilateral holes formed in the plates.

FIG. 22A shows a conventional example in which the beam shaper 13 was not used. A conventional processing apparatus was used to perform drilling. As a result, quadrilateral holes formed using the laser beam with the above-described incident beam diameters (B_{I}) all had rounded corners on the IN-side surfaces of the plates.

In FIG. 22B, the laser processing apparatus 100 of the first embodiment was used to drill quadrilateral holes of about 17 μm× about 17 μm. As a result, according to the laser processing apparatus 100, the quadrilateral holes drilled using the laser beam with the above-described incident beam diameters (B_{I}) were all formed in accurate shapes on the IN-side side surfaces of the plates.

In FIG. 22C, the laser processing apparatus 200 of the second embodiment was used to drill quadrilateral holes of about 17 μm× about 17 μm. As a result, according to the laser processing apparatus 200, the quadrilateral holes drilled using the laser beam with the above-described incident beam diameters (B_{I}) were all formed in accurate shapes on the IN-side side surfaces of the plates.

In FIG. 22D, the processing system 400 of the fourth embodiment was used to drill quadrilateral holes of about 17 μm× about 17 μm. As a result, according to the processing system 400, the quadrilateral holes drilled using the laser beam with the above-described incident beam diameters (B_{I}) were all formed in accurate shapes on the IN-side side surfaces and the OUT-side surfaces of the plates.

In particular, when the incident beam diameter (B_{I}) of the laser beam was 6.9 mm to 7.6 mm, the quadrilateral holes with small roundness at the corners on the IN-side surfaces were formed accurately in the first embodiment, the second embodiment, and the fourth embodiment. From these results, it was found that, by setting the ratio (Bₛ:B_{I}) of the standard incident beam diameter (Bₛ) set for the beam shaper 13 to the incident beam diameter (B_{I}) of the laser beam actually incident on the beam shaper 13 to 1.15 to 1.27, it becomes possible to perform micromachining with still higher accuracy in shape with respect to the IN-side surface of the workpiece T.

### Other Modifications

While the present disclosure has been described above with reference to exemplary embodiments, the present disclosure is by no means limited to the above embodiments. Various changes and modifications that may become apparent to those skilled in the art may be made in the configuration and specifics of the present disclosure without departing from the scope of the present disclosure.

(1) In the first to fourth embodiments, the outer peripheral shape of the beam of laser beam L emitted from the laser oscillator 11 and the shape of a hole formed in the workpiece T both may be any shape. The beam shaper may be selected according to a desired shape of a hole.

(2) In the first to fourth embodiments, laser beam L emitted from the laser oscillator 11 is not limited to a Gaussian beam, and the energy intensity distribution of the laser beam L may be any distribution. Although the polarized pattern of the laser beam L is linear polarization in the above embodiments, the polarized pattern is not limited to linear polarization and may be circular polarization or elliptical polarization.

(3) In the first to fourth embodiments, the mirror 14 and the processing stage 16 are optional components and may or may not be provided. In the case of drilling a minute hole with a size equivalent to the beam size of a rectangularly shaped beam, neither the mirror (galvanometer scanner) 14 nor the processing stage 16 is necessary in the first to fourth embodiments. In the first to fourth embodiments, by applying the rectangularly shaped beam onto the workpiece T, a quadrilateral hole having four sharp corners and having a size equivalent to the beam size can be formed accurately.

When drilling a hole larger than the above-described beam size, a quadrilateral hole with a desired size is formed in the workpiece T by scanning a rectangular beam using the mirror (galvanometer scanner) 14 or the processing stage 16. Since the rectangular beam has sufficiently high energy intensity at its four corners as described in the above first to fourth embodiments, a quadrilateral hole having four sharp corners and having a desired size can be formed as a result of the scanning.

(4) Although the eccentric optical system 121 of the beam rotator 12 is made up of two wedge prisms in the above first to fourth embodiments, the present invention is not limited thereto. For example, as the eccentric optical system 121, a Dove prism may be used or a convex lens and a concave lens may be used in combination, instead of the wedge prisms 121a and 121b. When the Dove prism is used as the eccentric optical system 121, laser beam Lis reflected inside the Dove prism, and the Dove prism thus can emit the laser beam L in a state of being eccentric from and in parallel with its central axis. When the convex lens and the concave lens are used in combination as the eccentric optical system 121, by arranging the convex lens and the concave lens so as to face each other, laser beam L is polarized when it is incident on and emitted from surfaces of the respective lenses, whereby the laser beam L is made eccentric. Thus, the convex lens and the concave lens can emit the laser beam L in a state of being eccentric from and in parallel with their central axes.

(5) In the above first to fourth embodiments, the XY stage 16 (processing stage) may be configured to be movable not only in the horizontal direction (Z direction) but also in the vertical direction. The vertical direction in this context means the direction orthogonal to the horizontal direction.

(6) In the first to fourth embodiments, the rotation mechanism 123 is rotated continuously such that Br1 to Br4 are positioned so as to form a circular shape on a plane orthogonal to the central axis. It is to be noted, however, that the present disclosure is not limited thereto, and the rotation mechanism 123 may be rotated such that Br1 to Br4 are positioned so as to form another circular shape such as an oval shape or a polygonal shape such as a quadrilateral shape.

(7) In the first to fourth embodiments, a diffractive optical element-type beam shaper is used as the beam shaper 13. It is to be noted, however, that the present invention is not limited thereto, and the beam shaper 13 may be: a beam shaper including a refractive optical element such as a microlens array: a spatial light modulator (LCOS-SLM); or the like. Further, in the above first to fourth embodiments, a beam shaper that converts the beam mode, i.e., a beam shaper that converts the energy intensity distribution of incident laser beam, is used. It is to be noted, however, that the present disclosure is not limited thereto, and for example, a beam shaping element or shaping member that converts the beam shape of incident laser beam, such as a slit, may be used.

(8) In the above first to fourth embodiments, a beam shaper that converts a Gaussian beam into a rectangular beam is used as the beam shaper 13. It is to be noted, however, that the beam shaper of the present disclosure is not limited thereto, and a beam shaper that converts a Gaussian beam into a triangular beam or a beam shaper that converts a Gaussian beam into a pentagonal beam may be used. That is, in the first to fourth embodiments, a beam shaper capable of converting a Gaussian beam into a polygonal beam may be used according to the desired shape of a hole.

(9) The laser processing apparatuses of the above first to fourth embodiments may also be used in production of probe cards.

(10) The above embodiments and the above modifications can be combined as appropriate.

This application is based upon and claims the benefit of priority from Japanese Patent Application No. 2021-151441 filed on Sep. 16, 2021, the entire disclosure of which is incorporated herein by reference.

### SUPPLEMENTARY NOTES

The whole or part of the exemplary embodiments and examples disclosed above can be described as, but not limited to, the following Supplementary Notes.

### <Laser Processing Apparatus>

### Supplementary Note 1

A laser processing apparatus for processing a workpiece by applying laser beam to the workpiece, the laser processing apparatus including:
a laser oscillation unit capable of emitting laser beam;
a beam conversion unit that converts the laser beam emitted from the laser oscillation unit into a circular beam having a predetermined diameter (e.g., outer peripheral diameter or outer diameter);
a polygonal beam shaping unit on which the circular beam emitted from the beam conversion unit is incident and from which a polygonal beam is emitted; and
a focusing optical system that focuses the polygonal beam emitted from the polygonal beam shaping unit on the workpiece,
wherein the polygonal beam shaping unit is a diffractive optical element-type beam shaper, and
an outer peripheral diameter of the circular beam incident on the diffractive optical element-type beam shaper is larger than a standard incident beam diameter preset for the diffractive optical element-type beam shaper.

### Supplementary Note 2

The laser processing apparatus according to Supplementary Note 1, wherein the beam conversion unit converts the laser beam into the circular beam in which energy intensity on a side closer to an outer periphery than to an optical axis thereof (of the laser beam) is higher than energy intensity near the optical axis.

### Supplementary Note 3

The laser processing apparatus according to Supplementary Note 1 or 2, wherein the beam conversion unit converts the laser beam into the circular beam that is in the form of an annular beam.

### Supplementary Note 4

The laser processing apparatus according to any one of Supplementary Notes 1 to 3,
wherein the beam conversion unit is a beam rotator that includes an eccentric optical system and a rotation mechanism,
the eccentric optical system emits laser beam incident thereon after making it eccentric, thereby causing the laser beam to be incident on the polygonal beam shaping unit at a position eccentric from a central axis thereof,
the rotation mechanism is capable of rotating the eccentric optical system, and
the beam conversion unit generates the circular beam by causing laser beam emitted therefrom to rotate along with rotation of the eccentric optical system.

### Supplementary Note 5

The laser processing apparatus according to Supplementary Note 4,
wherein the eccentric optical system is capable of adjusting an amount of eccentricity.

### Supplementary Note 6

The laser processing apparatus according to Supplementary Note 2 or 3,
wherein the beam conversion unit includes two axicon lenses, and the two axicon lenses generate the circular beam by converting a shape of the laser beam incident thereon.

### Supplementary Note 7

The laser processing apparatus according to any one of Supplementary Notes 1 to 6,
wherein a ratio (Bₛ:B_{I}) of a standard incident beam diameter (Bₛ) of the diffractive optical element-type beam shaper to an incident beam diameter (B_{I}) of the laser beam incident on the polygonal beam shaping unit is more than 1:1 and not more than 1:1.5, 1:1.08 to 1.33, or 1:1.15 to 1.26, more preferably 1:1.15 to 1.3 or 1:1.2 to 1.3, and still more preferably 1: about 1.2.

### Supplementary Note 8

The laser processing apparatus according to any one of Supplementary Notes 1 to 7, further including a scanning mechanism for moving the workpiece and the focusing optical system relative to each other in order to scan the laser beam from the focusing optical system on the workpiece.

### Supplementary Note 9

The laser processing apparatus according to Supplementary Note 8,
wherein the scanning mechanism is a processing stage that supports and moves the workpiece.

### Supplementary Note 10

The laser processing apparatus according to Supplementary Note 8,
wherein the scanning mechanism is a galvanometer scanner for scanning the laser beam focused by the focusing optical system.

### Supplementary Note 11

The laser processing apparatus according to any one of Supplementary Notes 1 to 10, further including a slit that corrects the polygonal beam emitted from the polygonal beam shaping unit to a desired shape (e.g., a polygonal shape or a circular shape).

### Supplementary Note 12

The laser processing apparatus according to any one of Supplementary Notes 1 to 11,
wherein the polygonal beam shaping unit converts the circular beam into a quadrilateral beam.

### Supplementary Note 13

The laser processing apparatus according to any one of Supplementary Notes 1 to 12,
wherein the beam conversion unit converts the laser beam emitted from the laser oscillation unit into a circular beam that has an averaged energy intensity distribution in a circular shape and has a predetermined diameter (e.g., outer peripheral diameter or outer diameter).

### Supplementary Note 14

A laser processing apparatus for processing a workpiece by applying laser beam to the workpiece, the laser processing apparatus including:

a laser oscillation unit capable of emitting laser beam:

a beam conversion unit that makes the laser beam emitted from the laser oscillation unit eccentric from an optical axis thereof (of the laser beam) and rotates the laser beam about the optical axis:

a diffractive optical element-type beam shaping unit on which the circular beam emitted from the beam conversion unit is incident and from which a polygonal beam is emitted; and

a focusing optical system that focuses the polygonal beam emitted from the diffractive optical element-type beam shaping unit on the workpiece.

### Supplementary Note 15

The laser processing apparatus according to Supplementary Note 14,
wherein the beam conversion unit converts the laser beam into the circular beam in which energy intensity on a side closer to an outer periphery than to an optical axis of the laser beam is higher than energy intensity near the optical axis.

### Supplementary Note 16

The laser processing apparatus according to Supplementary Note 14 or 15,
wherein the beam conversion unit converts the laser beam into the circular beam that is in the form of an annular beam.

### Supplementary Note 17

The laser processing apparatus according to any one of Supplementary Notes 14 to 16,
wherein the beam conversion unit is a beam rotator that includes an eccentric optical system and a rotation mechanism,
the eccentric optical system emits laser beam incident thereon after making it eccentric, thereby causing the laser beam to be incident on the polygonal beam shaping unit at a position eccentric from a central axis thereof,
the rotation mechanism is capable of rotating the eccentric optical system, and
the beam conversion unit generates the circular beam by causing laser beam emitted therefrom to rotate along with rotation of the eccentric optical system.

### Supplementary Note 18

The laser processing apparatus according to Supplementary Note 17,
wherein the eccentric optical system is capable of adjusting an amount of eccentricity.

### Supplementary Note 19

The laser processing apparatus according to Supplementary Note 15 or 16,
wherein the beam conversion unit includes two axicon lenses, and
the two axicon lenses generate the circular beam by converting a shape of the laser beam incident thereon.

### Supplementary Note 20

The laser processing apparatus according to any one of Supplementary Notes 14 to 19,
wherein a ratio (Bₛ:B_{I}) of a standard incident beam diameter (Bₛ) of the diffractive optical element-type beam shaper to an incident beam diameter (B_{I}) of the laser beam incident on the polygonal beam shaping unit is more than 1:1 and not more than 1:1.5, 1:1.08 to 1.33, or 1:1.15 to 1.26, more preferably 1:1.15 to 1.3 or 1:1.2 to 1.3, and still more preferably 1: about 1.2.

### Supplementary Note 21

The laser processing apparatus according to any one of Supplementary Notes 14 to 20, further including a scanning mechanism for moving the workpiece and the focusing optical system relative to each other in order to scan the laser beam from the focusing optical system on the workpiece.

### Supplementary Note 22

The laser processing apparatus according to Supplementary Note 21,
wherein the scanning mechanism is a processing stage that supports and moves the workpiece.

### Supplementary Note 23

The laser processing apparatus according to Supplementary Note 21,
wherein the scanning mechanism is a galvanometer scanner for scanning the laser beam focused by the focusing optical system.

### Supplementary Note 24

The laser processing apparatus according to any one of Supplementary Notes 14 to 23, further including a slit that corrects the polygonal beam emitted from the polygonal beam shaping unit to a desired shape (e.g., a polygonal shape or a circular shape).

### Supplementary Note 25

The laser processing apparatus according to any one of Supplementary Notes 14 to 24,
wherein the polygonal beam shaping unit converts the circular beam into a quadrilateral beam.

### Supplementary Note 26

The laser processing apparatus according to any one of Supplementary Notes 14 to 25,
wherein the beam conversion unit converts the laser beam emitted from the laser oscillation unit into a circular beam whose averaged energy intensity distribution has a circular shape and that has a predetermined diameter (e.g., outer peripheral diameter or outer diameter).

### Supplementary Note 27

The laser processing apparatus according to any one of Supplementary Notes 1 to 26, further including a communication unit,
wherein the communication unit is capable of communicating with a terminal,
the communication unit receives control information from the terminal and transmits the control information to a control unit, and
the control unit controls the laser processing apparatus based on the received control information.

### <Laser Processing System>

### Supplementary Note 28

A laser processing system including:
a terminal; and
a laser processing apparatus,
wherein the laser processing apparatus is the laser processing apparatus according to Supplementary Note 27.

### <Probe Card Production Method>

### Supplementary Note 29

A method for producing a probe card, the method including the step of:
drilling a hole in a board of a probe card using at least one of the laser processing apparatus according to any one of Supplementary Notes 1 to 27 or the laser processing system according to Supplementary Note 28.

### <Laser Processing Method>

### Supplementary Note 30

A laser processing method including:
drilling a hole having a desired shape (e.g., a polygonal shape or a circular shape) in a workpiece using at least one of the laser processing apparatus according to any one of Supplementary Notes 1 to 27 or the laser processing system according to Supplementary Note 28.

### <Laser Processing Method Using Laser Processing Apparatus>

### Supplementary Note 31

A laser processing method for use in a laser processing apparatus that includes a laser oscillation unit, a beam conversion unit, a polygonal beam shaping unit, and a focusing optical system, the laser processing method including:
a first step in which the beam conversion unit converts laser beam emitted from the laser oscillation unit into a circular beam having a predetermined diameter;
a second step in which the polygonal beam shaping unit shapes the circular beam emitted from the beam conversion unit into a polygonal beam; and
a third step in which the focusing optical system focuses the polygonal beam emitted from the polygonal beam shaping unit on a workpiece,
wherein, in the second step, a diffractive optical element-type beam shaper is used as the polygonal beam shaping unit, and an outer peripheral diameter of the circular beam incident on the diffractive optical element-type beam shaper is larger than a standard incident beam diameter preset for the diffractive optical element-type beam shaper.

### Supplementary Note 32

The laser processing method according to Supplementary Note 31, wherein, in the first step, the beam conversion unit converts the laser beam into the circular beam in which energy intensity on a side closer to an outer periphery than to an optical axis thereof (of the laser beam) is higher than energy intensity near the optical axis.

### Supplementary Note 33

The laser processing method according to Supplementary Note 31 or 32,
wherein, in the first step, the beam conversion unit converts the laser beam into the circular beam that is in the form of an annular beam.

### Supplementary Note 34

The laser processing method according to any one of Supplementary Notes 31 to 33,
wherein the beam conversion unit is a beam rotator that includes an eccentric optical system and a rotation mechanism,
the eccentric optical system emits laser beam incident thereon after making it eccentric, thereby causing the laser beam to be incident on the polygonal beam shaping unit at a position eccentric from a central axis thereof,
the rotation mechanism is capable of rotating the eccentric optical system, and
in the first step, the beam conversion unit generates the circular beam by causing laser beam emitted therefrom to rotate along with rotation of the eccentric optical system.

### (Supplementary Note 35)

The laser processing method according to Supplementary Note 34,
wherein the eccentric optical system is capable of adjusting an amount of eccentricity.

### Supplementary Note 36

The laser processing method according to Supplementary Note 32 or 33,
wherein the beam conversion unit includes two axicon lenses, and
in the first step, the two axicon lenses generate the circular beam by converting a shape of the laser beam incident thereon.

### Supplementary Note 37

The laser processing method according to any one of Supplementary Notes 31 to 36,
wherein a ratio (Bₛ:B_{I}) of a standard incident beam diameter (Bₛ) of the diffractive optical element-type beam shaper to an incident beam diameter (B_{I}) of the laser beam incident on the polygonal beam shaping unit is more than 1:1 and not more than 1:1.5, 1:1.08 to 1.33, or 1:1.15 to 1.26, more preferably 1:1.15 to 1.3 or 1:1.2 to 1.3, and still more preferably 1: about 1.2.

### Supplementary Note 38

The laser processing method according to any one of Supplementary Notes 31 to 37,
wherein the laser processing apparatus further includes a scanning mechanism for moving the workpiece and the focusing optical system relative to each other in order to scan the laser beam from the focusing optical system on the workpiece, and
in the third step, the scanning mechanism scans a focal position of the polygonal beam on the workpiece.

### Supplementary Note 39

The laser processing method according to Supplementary Note 38,
wherein the scanning mechanism is a processing stage that supports and moves the workpiece.

### Supplementary Note 40

The laser processing method according to Supplementary Note 38,
wherein the scanning mechanism is a galvanometer scanner for scanning the laser beam focused by the focusing optical system.

### Supplementary Note 41

The laser processing method according to any one of Supplementary Notes 31 to 40,
wherein the laser processing apparatus further includes a slit that corrects the polygonal beam emitted from the polygonal beam shaping unit to a desired shape (e.g., a polygonal shape or a circular shape),
the laser processing method further includes a fourth step in which the slit corrects the polygonal beam emitted from the polygonal beam shaping unit to the desired shape, and
in the third step, the focusing optical system focuses the beam emitted from the slit and having the desired shape on the workpiece.

### Supplementary Note 42

The laser processing method according to any one of Supplementary Notes 31 to 41,
wherein, in the second step, the polygonal beam shaping unit converts the circular beam into a quadrilateral beam.

### Supplementary Note 43

The laser processing method according to any one of Supplementary Notes 31 to 42,
wherein, in the first step, the beam conversion unit converts the laser beam emitted from the laser oscillation unit into a circular beam that has an averaged energy intensity distribution in a circular shape and has a predetermined diameter (e.g., outer peripheral diameter or outer diameter).

### Supplementary Note 44

A laser processing method for use in a laser processing apparatus that includes a laser oscillation unit, a beam conversion unit, a polygonal beam shaping unit, and a focusing optical system, the laser processing method including:
a first step in which the beam conversion unit makes the laser beam emitted from the laser oscillation unit eccentric from an optical axis thereof (of the laser beam) and rotates the laser beam about the optical axis:

a second step in which the polygonal beam shaping unit shapes the circular beam emitted from the beam conversion unit into a polygonal beam; and
a third step in which the focusing optical system focuses the polygonal beam emitted from the polygonal beam shaping unit on a workpiece.

### Supplementary Note 45

The laser processing method according to Supplementary Note 44,
wherein, in the first step, the beam conversion unit converts the laser beam into the circular beam in which energy intensity on a side closer to an outer periphery than to an optical axis of the laser beam is higher than energy intensity near the optical axis.

### Supplementary Note 46

The proposal method according to Supplementary Note 44 or 45,
wherein, in the first step, the beam conversion unit converts the laser beam into the circular beam that is in the form of an annular beam.

### Supplementary Note 47

The laser processing method according to any one of Supplementary Notes 44 to 46,
wherein the beam conversion unit is a beam rotator that includes an eccentric optical system and a rotation mechanism,
the eccentric optical system emits laser beam incident thereon after making it eccentric, thereby causing the laser beam to be incident on the polygonal beam shaping unit at a position eccentric from a central axis thereof,
the rotation mechanism is capable of rotating the eccentric optical system, and
in the first step, the beam conversion unit generates the circular beam by causing laser beam emitted therefrom to rotate along with rotation of the eccentric optical system.

### Supplementary Note 48

The laser processing method according to Supplementary Note 47,
wherein the eccentric optical system is capable of adjusting an amount of eccentricity.

### Supplementary Note 49

The laser processing method according to Supplementary Note 45 or 46,
wherein the beam conversion unit includes two axicon lenses, and
in the first step, the two axicon lenses generate the circular beam by converting a shape of the laser beam incident thereon.

### Supplementary Note 50

The laser processing method according to any one of Supplementary Notes 44 to 49,
wherein a ratio (Bₛ:B_{I}) of a standard incident beam diameter (Bₛ) of the diffractive optical element-type beam shaper to an incident beam diameter (B_{I}) of the laser beam incident on the polygonal beam shaping unit is more than 1:1 and not more than 1:1.5, 1:1.08 to 1.33, or 1:1.15 to 1.26, more preferably 1:1.15 to 1.3 or 1:1.2 to 1.3, and still more preferably 1: about 1.2.

### Supplementary Note 51

The laser processing method according to any one of Supplementary Notes 44 to 50,
wherein the laser processing apparatus further includes a scanning mechanism for moving the workpiece and the focusing optical system relative to each other in order to scan the laser beam from the focusing optical system on the workpiece, and
in the third step, the scanning mechanism scans a focal position of the polygonal beam on the workpiece.

### Supplementary Note 52

The laser processing method according to Supplementary Note 51,
wherein the scanning mechanism is a processing stage that supports and moves the workpiece.

### Supplementary Note 53

The laser processing method according to Supplementary Note 51,
wherein the scanning mechanism is a galvanometer scanner for scanning the laser beam focused by the focusing optical system.

### Supplementary Note 54

The laser processing method according to any one of Supplementary Notes 44 to 53,
wherein the laser processing apparatus further includes a slit that corrects the polygonal beam emitted from the polygonal beam shaping unit to a desired shape (e.g., a polygonal shape or a circular shape),
the laser processing method further includes a fourth step in which the slit corrects the polygonal beam emitted from the polygonal beam shaping unit to the desired shape, and
in the third step, the focusing optical system focuses the beam emitted from the slit and having the desired shape on the workpiece.

### Supplementary Note 55

The laser processing method according to any one of Supplementary Notes 44 to 54,
wherein the polygonal beam shaping unit converts the circular beam into a quadrilateral beam.

### <Probe Card Production Method>

### Supplementary Note 56

A method for producing a probe card, the method including the step of:
drilling a hole in a probe card board,
wherein the drilling step is performed by the laser processing method according to any one of Supplementary Notes 31 to 55.

### INDUSTRIAL APPLICABILITY

The laser processing apparatus according to the present invention is capable of drilling a hole having corners with high accuracy in shape with respect to an IN-side surface of a workpiece. The laser processing apparatus according to the present invention can be suitably applied to probe cards and also can be suitably applied to other technical fields involving laser processing.

### REFERENCE SIGNS LIST

400: Laser processing system
100, 200, 300, 401: Laser processing apparatus
402: Terminal
11: Laser oscillation unit (laser oscillator)
12, 12A: Beam rotator
121: Eccentric optical system
121a, 121b: Wedge prism
123, 123a: Rotation mechanism (second rotation mechanism)
124: Servo motor (second rotation actuator)
124a, 124b: Axicon lens
125: Second servo amplifier
13: Beam shaper
14: Mirror (galvanometer scanner)
15: Focusing optical system (condenser lens)
16: XY stage (processing stage)
17: Slit (beam shaping unit)
18: Beam shaping optical system
19: Polarization rotator (polarization rotator unit)
191: λ/2 plate (wave plate)
193: Rotation mechanism (first rotation mechanism)
194: Servo motor (first rotation actuator)
195: First servo amplifier
20: Control unit
201: Motor synchronous control unit
202: Laser optical control unit
21: Communication unit

1. A laser processing apparatus for processing a workpiece by applying laser beam to the workpiece, the laser processing apparatus comprising:
a laser oscillator capable of emitting laser beam;
a beam converter that converts the laser beam emitted from the laser oscillator into a circular beam having a predetermined diameter;
a diffractive optical element-type beam shaper on which the circular beam emitted from the beam converter unit is incident and from which a polygonal beam is emitted; and
a focusing optical system that focuses the polygonal beam emitted from the polygonal beam shaping unit on the workpiece,
wherein
an outer peripheral diameter of the circular beam incident on the diffractive optical element-type beam shaper is larger than a standard incident beam diameter preset for the diffractive optical element-type beam shaper.

2. The laser processing apparatus according to claim 1,
wherein the beam converter converts the laser beam into the circular beam in which energy intensity on a side closer to an outer periphery than to an optical axis thereof is higher than energy intensity near the optical axis.

3. The laser processing apparatus according to claim 1,
wherein the beam converter converts the laser beam into the circular beam that is in the form of an annular beam.

4. The laser processing apparatus according to claim 1,
wherein the beam converter unit is a beam rotator that includes an eccentric optical system and a rotation mechanism,
the eccentric optical system emits laser beam incident thereon after making it eccentric, thereby causing the laser beam to be incident on the diffractive optical element-type beam shaper at a position eccentric from a central axis thereof,
the rotation mechanism is capable of rotating the eccentric optical system, and
the beam converter generates the circular beam by causing laser beam emitted therefrom to rotate along with rotation of the eccentric optical system.

5. The laser processing apparatus according to claim 4,
wherein the eccentric optical system is capable of adjusting an amount of eccentricity.

6. The laser processing apparatus according to claim 2,
wherein the beam converter includes two axicon lenses, and
the two axicon lenses generate the circular beam by converting a shape of the laser beam incident thereon.

7. The laser processing apparatus according to claim 1,
wherein a ratio (Bₛ:B_{I}) of a standard incident beam diameter (Bₛ) of the diffractive optical element-type beam shaper to an incident beam diameter (B_{I}) of the laser beam incident on the diffractive optical element-type beam shaper is more than 1:1 and not more than 1:1.5.

8. The laser processing apparatus according to claim 1, further comprising a scanning mechanism for moving the workpiece and the focusing optical system relative to each other in order to scan the laser beam from the focusing optical system on the workpiece.

9. The laser processing apparatus according to claim 8,
wherein the scanning mechanism is a processing stage that supports and moves the workpiece.

10. The laser processing apparatus according to claim 8,
wherein the scanning mechanism is a galvanometer scanner for scanning the laser beam focused by the focusing optical system.

11. The laser processing apparatus according to claim 1, further comprising a slit that corrects the polygonal beam emitted from the diffractive optical element-type beam shaper to a desired shape.

12. The laser processing apparatus according to claim 1,
wherein the diffractive optical element-type beam shaper converts the circular beam into a quadrilateral beam.

13. A laser processing apparatus for processing a workpiece by applying laser beam to the workpiece, the laser processing apparatus comprising:
a laser oscillator capable of emitting laser beam;
a beam converter that makes the laser beam emitted from the laser oscillator eccentric from an optical axis thereof and rotates the laser beam about the optical axis;
a diffractive optical element-type beam shaper on which the circular beam emitted from the beam converter is incident and from which a polygonal beam is emitted; and
a focusing optical system that focuses the polygonal beam emitted from the diffractive optical element-type beam shaper on the workpiece.

14. A method for producing a probe card, the method comprising:
drilling a hole in a board of a probe card using the laser processing apparatus according to claim 1.

15. A laser processing method comprising:
drilling a hole having a desired shape in a workpiece using the laser processing apparatus according to claim 1.

16. A laser processing method for use in a laser processing apparatus that includes a laser oscillator, a beam converter, a diffractive optical element-type beam shaper, and a focusing optical system, the laser processing method comprising:
converting laser beam emitted from the laser oscillator into a circular beam having a predetermined diameter by the beam converter;
shaping the circular beam emitted from the beam converter into a polygonal beam by the diffractive optical element-type beam shaper; and
focusing the polygonal beam emitted from the diffractive optical element-type beam shaper on a workpiece by the focusing optical system,
wherein, an outer peripheral diameter of the circular beam incident on the diffractive optical element-type beam shaper is larger than a standard incident beam diameter preset for the diffractive optical element-type beam shaper.

17. The laser processing apparatus according to claim 1,
wherein the beam converter comprises a beam rotator, axicon lenses, or a combination of a convex conical mirror and a concave conical mirror.
